(19) United States
(12) Patent Application Publication
(10) Pub. No.: US 2022/0209327 A1
(43) Pub. Date: Jun. 30, 2022

(54) TEMPERATURE MANAGEMENT FOR ELECTROCHEMICAL CELLS

(71) Applicant: Sion Power Corporation, Tucson, AZ (US)

(72) Inventors: Glenn Alan Hamblin, Tucson, AZ (US); Mark Niedzwiecki, Tucson, AZ (US); Jared M. Jennings, Tucson, AZ (US); Daniel G. Milobar, Tucson, AZ (US); Shea Thomas Ribblett, Vail, AZ (US)

(73) Assignee: Sion Power Corporation, Tucson, AZ (US)

(21) Appl. No.: 17/565,317

(22) Filed: Dec. 29, 2021

Related U.S. Application Data
(60) Provisional application No. 63/132,049, filed on Dec. 30, 2020.

(51) Int. Cl. H01M 10/6551; H01M 10/6571; H01M 10/653; H01M 10/615

(52) U.S. Cl. CPC H01M 10/6551; H01M 10/615; H01M 10/653; H01M 10/6571

(57) ABSTRACT

Batteries typically include cells that undergo electrochemical reactions to produce electric current. Use of batteries in low temperature environments may adversely impact cell performance. Certain embodiments of the present disclosure are directed to inventive articles, systems, and methods that address cell performance issues in low temperature environments.

### RELATED APPLICATIONS

This application claims priority under 35 U.S.C. § 119(e) to U.S. Provisional Patent Application No. 63/132,049 filed Dec. 30, 2020, and entitled “Temperature Management for Electrochemical Cells,” which is incorporated herein by reference in its entirety for all purposes.

### TECHNICAL FIELD

Temperature management for electrochemical cells and related articles and systems are generally described.

### BACKGROUND

Batteries typically include cells that undergo electrochemical reactions to produce electric current. Use of batteries in low temperature environments may adversely impact cell performance. Certain embodiments of the present disclosure are directed to inventive articles, systems, and methods that address cell performance issues in low temperature environments.

### SUMMARY

Temperature management for electrochemical cells and related articles and systems are generally described. The subject matter of the present invention involves, in some cases, interrelated products, alternative solutions to a particular problem, and/or a plurality of different uses of one or more systems and/or articles.

In one aspect, a stack of electrochemical cells is described. In some embodiments, the stack of electrochemical cells comprises: a first electrochemical cell; a second electrochemical cell; a thermally conductive solid article portion at least partially between the first electrochemical cell and the second electrochemical cell; and a heater in thermal communication with the thermally conductive solid article portion.

In another aspect, a method is described. In some embodiments, the method comprises heating a region of a thermally conductive solid article portion to form a heated region, wherein: the thermally conductive solid article portion is at least partially between a first electrochemical cell and a second electrochemical cell of a stack of electrochemical cells, and the heating of the region results in at least some heat from the heated region of the thermally conductive solid article portion being transferred to the first electrochemical cell.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1C show cross-sectional schematic diagrams of exemplary stacks of electrochemical cells, including electrochemical cells, thermally conductive solid article portions, and heaters, according to certain embodiments;

FIGS. 2A-2B show cross-sectional schematic diagrams of exemplary stacks comprising electrochemical cells, thermally conductive solid article portions, and a thermally insulating compressible solid article portion, according to some embodiments;

FIG. 3 shows a cross-sectional schematic diagram of an exemplary electrochemical cell, according to some embodiments;

FIG. 4 shows a cross-sectional schematic diagram of an exemplary battery comprising electrochemical cells and an optional housing, according to some embodiments;

FIG. 5 shows a cross-sectional schematic diagram of an exemplary battery and solid plates, according to some embodiments;

FIGS. 6A-6B show cross-sectional schematic diagrams of exemplary stacks of electrochemical cells comprising electrochemical cells, thermally conductive solid article portions, a thermally insulating compressible solid article portion, and a solid plate in the absence and presence of an anisotropic force, respectively, according to some embodiments;

FIG. 7 shows a cross-sectional schematic diagram of an exemplary stack comprising an electrochemical cell, thermally conductive solid article portion, and a thermally insulating compressible solid article portion, according to some embodiments;

FIGS. 8A-8B show cross-sectional schematic diagrams of exemplary stacks of electrochemical cells comprising electrochemical cells and a thermally insulating compressible solid article portion, according to some embodiments;

FIGS. 9A-9B show cross-sectional schematic diagrams of an exemplary stack of electrochemical cells comprising electrochemical cells and a thermally insulating compressible solid article portion in the absence and presence of an anisotropic force, respectively, according to some embodiments;

FIGS. 10A-10F show cross-sectional schematic diagrams of exemplary stacks of electrochemical cells comprising electrochemical cells, thermally conductive solid article portions, and thermally insulating compressible solid article portions, according to some embodiments; FIGS. 11A-11E show perspective (FIGS. 11A-11B), exploded (FIGS. 11C-11D) and side-view (FIG. 11E) schematic diagrams of an exemplary battery, comprising an exemplary stack of electrochemical cells, including electrochemical cells, heaters, and thermally conductive solid article portions, according to certain embodiments;

FIGS. 12A-12C show top view (FIG. 12A), perspective view (FIG. 12B), and bottom-view (FIG. 12C) schematic illustrations of a thermal spreader, according to certain embodiments;

FIGS. 13A-13C show top view (FIG. 13A), perspective view (FIG. 13B), and bottom-view (FIG. 13C) schematic illustrations of a thermal spreader, according to certain embodiments; and FIG. 14 shows a cross sectional schematic diagram of an exemplary electric vehicle comprising a battery, according to some embodiments.

### DETAILED DESCRIPTION

Batteries typically include cells that undergo electrochemical reactions to produce electric current. Use of batteries in low temperature environments may adversely impact cell performance. Certain embodiments of the present disclosure are directed to inventive articles, systems, and methods that address cell performance issues in low temperature environments.

For some applications, it may be beneficial to heat components of a stack of electrochemical cells. For instance, in some cases, heating components of a stack of electrochemical cells (e.g., a first electrochemical cell, a second electrochemical cell) can improve the performance of the stack of electrochemical cells at low ambient temperatures. One such example is a stack of electrochemical cells operating at high altitudes, where the ambient temperature may drop to as low as −90° C. It has been recognized, in the context of the present disclosure, that under these conditions, heating a stack of electrochemical cells may beneficially improve performance (e.g., charge rate, discharge rate, cycle life, capacity, and the like) of a stack of electrochemical cells. For example, it has been recognized in the context of the present disclosure that electrochemical cells discharged at ambient temperatures at or exceeding 10° C. may, in some instances, be able to deliver a greater portion of their maximum capacity and to maintain a greater voltage than identical electrochemical cells discharged at temperatures below 10° C. However, it has also been realized, in the context of the present disclosure, that some stacks of electrochemical cells respond poorly to excessive heat. In some such cases, uniformity of heating can be important for imparting sustained improvements in performance. For example, non-uniform heating of stacks electrochemical cells comprising lithium metal or a lithium metal alloy as an electrode active material can lead to failure of electrochemical cells, which can lead to safety hazards.

The present disclosure provides systems and methods that can, in some cases, be used to mitigate the detrimental effects of low ambient temperature on the charge and discharge rates (and/or or other properties) of stacks of electrochemical cells. Further, certain components (e.g., thermally conductive solid article portions) in the stack of electrochemical cell may enhance the uniformity of heating of the stack of electrochemical cells. Some thermally conductive solid article portions may be capable of serving multiple roles (e.g., uniformly heating an electrochemical cell, aligning components of the stack of electrochemical cells). Certain aspects also relate to the construction of batteries comprising stacks of electrochemical cells, wherein anisotropic force may be applied to the battery, and wherein homogeneous pressure distribution, uniform heating, and/or low dimensional changes of the overall battery (e.g., the housing) are important to the overall function of the battery. Thermally insulating compressible solid article portions may also be present, which can be capable of serving multiple roles such as compensating for dimensional changes in electrochemical cells and mitigating heat transfer between electrochemical cells.

In one aspect, stacks of electrochemical cells (which may be arranged, for example, as a battery) are generally described. The stack may include, in some embodiments, one or more rechargeable electrochemical cells. In some embodiments, the stack comprises one or more rechargeable lithium-ion electrochemical cells.

The stacks of electrochemical cells disclosed herein are generally configured to include a first electrochemical cell, a second electrochemical cell, and a thermally conductive solid article portion. In some embodiments, the thermally conductive solid article portion is at least partially between the first electrochemical cell and the second electrochemical cell.

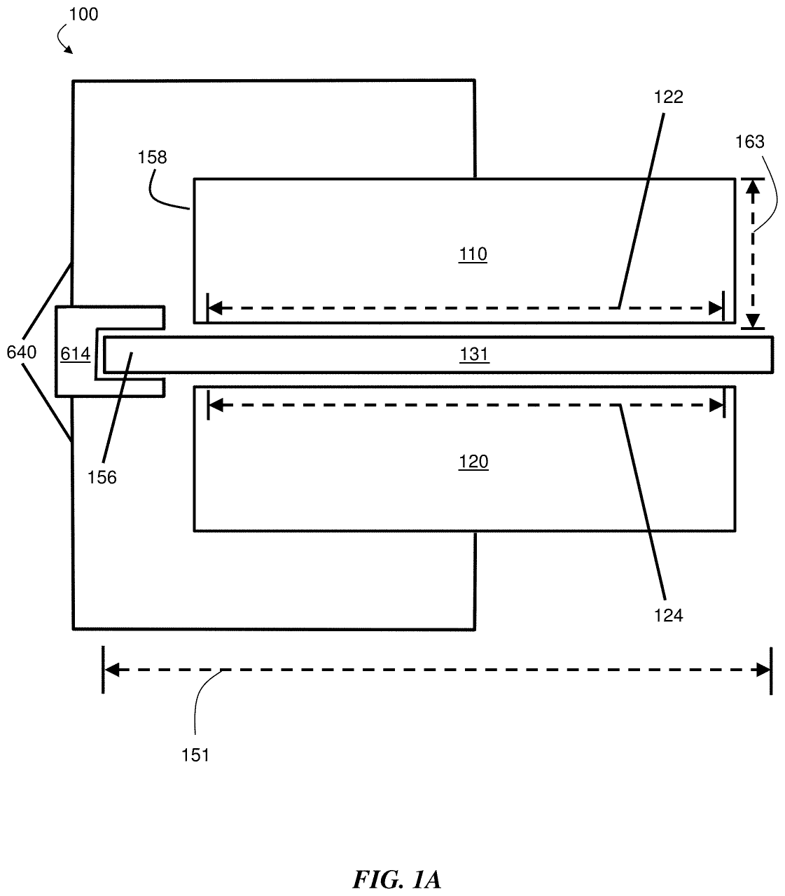

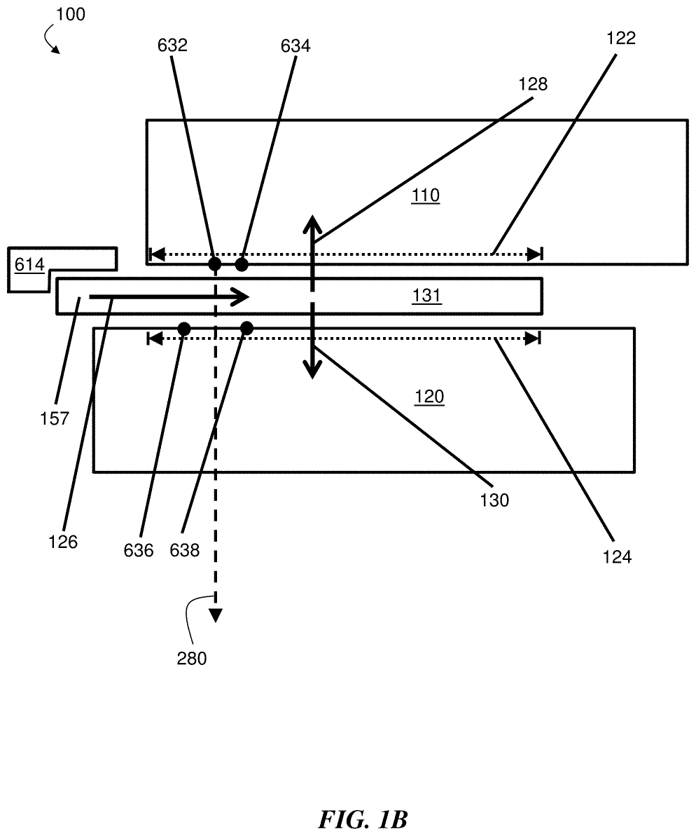

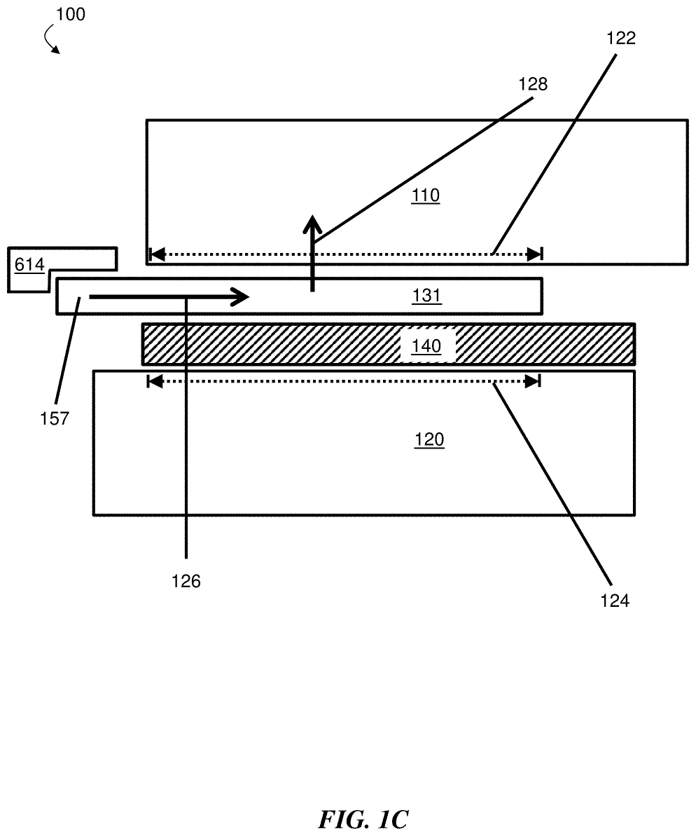

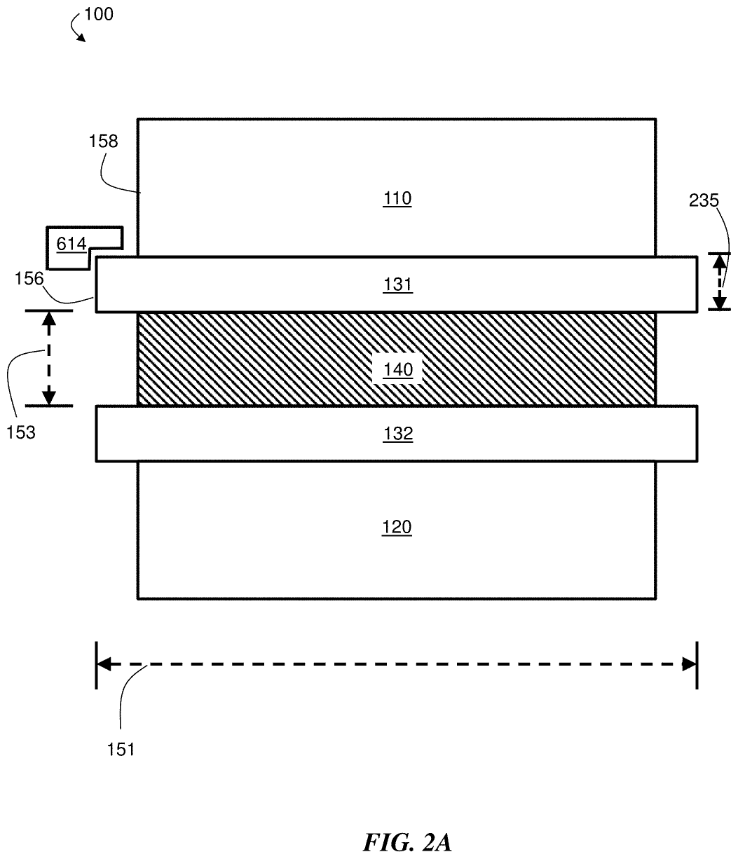

As noted above, certain aspects are directed to stacks of electrochemical cells. FIG. 1A is a cross-sectional schematic illustration of exemplary stack 100 of electrochemical cells, which comprises first electrochemical cell 110, second electrochemical cell 120, and thermally conductive solid article portion 131.

In some embodiments, the stack of electrochemical cells further comprises a heater in thermal communication with the thermally conductive solid article portion. For example, in FIG. 1A, heater 614 is in thermal communication with thermally conductive solid article portion 131. In some embodiments, the heater is lateral to one or more of the electrochemical cells (e.g., the first electrochemical cell). For instance, in FIG. 1A, heater 614 is lateral to first electrochemical cell 110 and second electrochemical cell 120, and in FIG. 1B, heater 614 is lateral to first electrochemical cell 110 but not second electrochemical cell 120. In some embodiments, a region of the thermally conductive solid article portion is lateral to the first electrochemical cell. For example, in FIG. 1A, region 156 of thermally conductive solid article portion 131 is lateral to first electrochemical cell 110. In some embodiments, the heater is relatively close to a region of the thermally conductive solid article portion that is lateral to the first electrochemical cell. For example, at least a portion of the heater may be within 5 cm, within 2 cm, with 1 cm, within 5 mm, within 2 mm, within 1 mm, within 0.5 mm, or less of a region of the thermally conductive solid article portion. In some embodiments, the heater is in direct contact with a region of the thermally conductive solid article portion (e.g., a region lateral to the first electrochemical cell).

In general, between two points in thermal communication, there exists at least one path through solid material having a thermal conductivity of greater than or equal to 0.5 W m⁻¹ K⁻¹ at a temperature of 25° C. In some embodiments, between two points in thermal communication, there exists at least one path through solid material having a thermal conductivity of greater than or equal to 1 W m⁻¹ K⁻¹, greater than or equal to 2 W m⁻¹ K⁻¹, greater than or equal to 5 W m⁻¹ K⁻¹, greater than or equal to 10 W m⁻¹ K⁻¹, greater than or equal to 25 W m⁻¹ K⁻¹, greater than or equal to 50 W m⁻¹ K⁻¹, greater than or equal to 65 W m⁻¹ K⁻¹, greater than or equal to 80 W m⁻¹ K⁻¹, greater than or equal to 100 W m⁻¹ K⁻¹, greater than or equal to 150 W m⁻¹ K⁻¹, greater than or equal to 159 W m⁻¹ K⁻¹, greater than or equal to 200 W m⁻¹ K⁻¹, greater than or equal to 250 W m⁻¹ K⁻¹, or greater at a temperature of 25° C. In some embodiments, between two points in thermal communication, there exists at least one path through solid material having a thermal conductivity of up to 300 W m⁻¹ K⁻¹, or greater at a temperature of 25° C. Objects (e.g., heaters, thermally conductive solid article portions, electrochemical cells) that are in thermal communication may be, in some embodiments, in direct contact with one another. However, objects in thermal communication may also be separated by one or more intervening elements (e.g., layers), provided that the thermal conductivity ranges above are satisfied.

Certain aspects are directed to methods of heating. In some embodiments, methods of heating comprise heating a region of a thermally conductive solid article portion to form a heated region. In some embodiments, the region is lateral to the first electrochemical cell. Heating the region may result in at least some heat from the heated region being transferred to the first electrochemical cell. In some embodiments, the thermally conductive solid article portion can form a region of overlap between the first and/or second electrochemical cell and the thermally conductive solid article portion.

In some embodiments, a region of thermally conductive solid article portion is heated to form a heated region. For example, FIG. 1B presents a cross-sectional schematic illustration of stack of electrochemical cells 100 where region 156 from FIG. 1A has been heated by heater 614 to form heated region 157 lateral to first electrochemical cell 110. The region may be lateral to one or more of the electrochemical cells (e.g., the first electrochemical cell). As an illustration, in FIG. 1A, region 156 of thermally conductive solid article portion 131 is lateral to first electrochemical cell 110, since it is positioned beyond lateral edge 158 of first electrochemical cell 110.

In some embodiments, the thermally conductive solid article portion is in thermal communication with a heater during heating. In some embodiments, the heater heats a region of the thermally conducting solid article portion, to form a heated region. In some embodiments, heat from a heated region can be conducted through the thermally conductive solid article portion. At least some heat from the heated region may be transferred to the first electrochemical cell.

In some embodiments, thermally conductive solid article portions and electrochemical cells overlap each other. Here, an electrochemical cell is considered to “overlap” a thermally conductive solid article portion at a point on the surface of the electrochemical cell if a ray perpendicular to the in-plane directions of the electrochemical cell and oriented away from the electrochemical cell passes through the thermally conductive solid article portion. For example, in FIG. 1B, ray 280 perpendicular to the in-plane directions of first electrochemical cell 110 and oriented away from first electrochemical cell 110 overlaps thermally conductive solid article portion 131 at point of overlap 632, where it originates. The collection of points of an electrochemical cell that overlap a thermally conductive solid article portion is said to be a region of overlap between the electrochemical cell and the thermally conductive solid article portion. For example, in FIG. 1B, the collection of points of electrochemical cell 110 that overlap thermally conductive solid article portion 131 form region of overlap 122 between first electrochemical cell 110 and thermally conductive solid article portion 131. In some embodiments, the thermally conductive solid article portion contacts the electrochemical cell directly at a point of overlap. In other embodiments, these points are separated by at least one intervening article.

In some embodiments, heat from the heater can be transferred heat to the first electrochemical cell through a region of overlap between the first electrochemical cell and the thermally conductive solid article portion. For example, in FIG. 1B, heat 126 from heated region 157 is conducted through the thermally conductive solid article portion 131. First region of overlap 122 between first electrochemical cell 110 and thermally conductive solid article portion 131 may receive transferred heat 128 from thermally conductive solid article portion 131. In some embodiments, heat is transferred from the heater to a region of the thermally conductive solid article portion that is lateral to the first electrochemical cell to generate a heated region, and heat from the heated region is then transferred, through the thermally conductive solid article portion, to a region of the thermally conductive solid article portion at the region of overlap between the first electrochemical cell and the thermally conductive solid article portion, and then that heat is transferred to the first electrochemical cell via that region of overlap. In some embodiments, less than or equal to 50 volume percent (vol %), less than or equal to 25 vol %, less than or equal to 10 vol %, less than or equal to 5 vol %, less than or equal to 1 vol %, or less of the heater overlaps with a region of overlap between the first electrochemical cell and the thermally conductive solid article portion. In some embodiments, none of the heater overlaps within a region of overlap between the first electrochemical cell and the thermally conductive solid article portion.

In some embodiments, at least some heat from the heated region can be transferred to the second electrochemical cell. In some embodiments, the transferred heat can enter the second electrochemical cell through a region of overlap between the second electrochemical cell and the thermally conductive solid article portion. For example, in FIG. 1B, second region of overlap 124 between second electrochemical cell 120 and thermally conductive solid article portion 131 receives transferred heat 130 from thermally conductive solid article portion 131.

In some embodiments, the lateral position of a heater and/or a heated region of a thermally conductive solid article portion with respect to an electrochemical cell (e.g., a first electrochemical cell) facilitates more uniform heating of a stack of electrochemical cells than implementations where such a lateral positioning is not used. For example, the lateral position of the heater and/or the heated region may eliminate the need for direct contact or close proximity between the heater and/or the heated region and an electrochemical cell. Direct contact or close proximity between the heater and/or the heated region and the electrochemical cell may result in greater heat transfer to that portion of the electrochemical cell, resulting in the formation of a large temperature gradient that could adversely affect cell performance. In some embodiments, lateral placement of the heater and/or heated region promotes a greater portion of heat from the heater and/or heated region traveling through the thermally conductive solid article portion before it is transferred to the electrochemical cell. The transfer of a greater portion of heat through the thermally conductive solid article portion may result in a reduced temperature gradient of the electrochemical cell compared to implementations where the heater is located, for example, within a region of overlap with the electrochemical cell. It has also been realized in the context of this disclosure that a lateral position of the heater (rather than in an interior portion of the stack of electrochemical cells) may facilitate access to (and repair and/or replacement of) the heater without requiring disassembly of portions of the stack involving the electrochemical cells themselves. In such a way, configurations described in this disclosure can promote ease of manipulation of heaters (via lateral positioning) while also promoting uniform heating (e.g., at least in part due to propagation of heat via a thermally conductive solid article portion at least partially between electrochemical cells).

In some embodiments, at least a portion of the thermally conductive solid article portion are separated from an electrochemical cell (e.g., the second electrochemical cell) by a thermally insulating element (e.g., a thermally insulating compressible solid article portion). The thermally insulating element may, in some cases, reduce or prevent transfer of heat from the thermally conductive solid article portion to a region of overlap between the second electrochemical cell and the thermally conductive solid article portion. Such a reduction or elimination of heat transfer to the region of overlap may prevent heat from a first electrochemical cell (e.g., experiencing thermal runaway) from adversely affecting the performance of a second electrochemical cell. For example, FIG. 1C presents a cross-sectional schematic illustration of stack of electrochemical cells 100 where a region (e.g., lateral region) has been heated by heater 614 to form heated region 157, wherein thermally insulating compressible solid article portion 140 reduces or prevents the transfer of heat from heated region 157 to second region of overlap 124 between second electrochemical cell 120 and thermally conductive solid article portion 131.

In some embodiments, methods of heating provide uniform heating under steady-state conditions. When methods of heating reach steady-state conditions, the temperature of a region of overlap between the first and/or second electrochemical cell and the thermally conductive solid article portion may be uniform. For example, methods of heating may ensure that under steady-state conditions, the temperature difference between any two points of the first electrochemical cell within a region of overlap between the first electrochemical cell and the thermally conductive solid article portion does not exceed 15° C., does not exceed 10° C., does not exceed 5° C., does not exceed 2° C., and/or does not exceed 1° C. For example, in FIG. 1B, under steady-state heating, the temperature difference between arbitrary first point 632 and arbitrary second point 634 of first electrochemical cell 110 within first region of overlap 122 (or any other two points of first electrochemical call 110 within first region of overlap 122) does not exceed 10° C.

In some embodiments, methods of heating ensure that under steady-state conditions, the temperature difference between any two points of the second electrochemical cell within a region of overlap between the second electrochemical cell and the thermally conductive solid article portion is less than or equal to 15° C., is less than or equal to 10° C., is less than or equal to 5° C., is less than or equal to 2° C., is less than or equal to 1° C., and/or is less. For example, in FIG. 1B, under steady-state heating, the temperature difference between arbitrary first point 636 and arbitrary second point 638 of second electrochemical cell 120 within second region of overlap 124 (or any other two points of second electrochemical call 120 within second region of overlap 124) does not exceed 10° C.

In some embodiments, heat is dissipated by a heater. In some embodiments, the heater is a resistive heater. In some cases, the heater is electronically coupled to the stack of electrochemical cells. In some embodiments, the stack of electrochemical cells provides power to the heater. For example, in FIG. 1A, electronic coupling 640 electronically couples resistive heater 614 to stack of electrochemical cells 100, allowing stack of electrochemical cells 100 to provide power to heater 614. The stack of electrochemical cells may be electronically coupled to the heater, for example, via an electronic circuit (e.g., an electronic circuit comprising at least one electrochemical cell of the stack of electrochemical cells, the heater (e.g., a resistive heater), electronic coupling (e.g., electrical wiring), and, in some instances a controller such as one that is part of a printed circuit board).

In some cases, the heater is lateral to a first electrochemical cell of a stack of electrochemical cells. For example, in FIG. 1A-1C, heater 614 is lateral to first electrochemical cell 110 of stack of electrochemical cells 100. However, in some embodiments, the heater or a portion of the heater is not lateral to the first electrochemical cells. The heater may overlap a portion of one or more sides of the thermally conductive solid article portion, and/or overlap a portion of one or more edges of the thermally conductive solid article portion, or may otherwise be positioned in whatever way is favorable, provided that it is in thermal communication with the thermally conductive solid article portion. For example, in FIG. 1A, heater 614 overlaps both a portion of a first side of thermally conductive solid article portion 131, a portion of a second side of thermally conductive solid article portion 131, and a portion of an edge of thermally conductive solid article portion 131, whereas in FIG. 1B, heater 614 only overlaps a portion of a first side of thermally conductive solid article portion 131 and a portion of an edge of thermally conductive solid article 131.

The heater may directly contact a region of the thermally conductive solid article portion. However, the heater and the thermally conductive solid article portion may also be separated by one or more intervening layers (e.g., sensors), provided that the heater and the thermally conductive solid article portion remain in thermal communication.

In some embodiments, the heater is configured to dissipate a relatively high thermal power. In some embodiments, the heater is configured to dissipate a thermal power of greater than or equal to 0.01 W, greater than or equal to 0.05 W, greater than or equal to 0.1 W, greater than or equal to 0.5 W, greater than or equal to 1 W, or greater. In some embodiments, the heater is configured to dissipate a thermal power of less than or equal to 10 W, less than or equal to 5 W, less than or equal to 1 W, less than or equal to 0.5 W, or less. Combinations of these values are also possible (e.g., the heater may be configured to dissipate a thermal power of between or equal to 0.1 W and 10 W).

Embodiments in which heaters dissipate greater than 10 W of thermal power are also contemplated. In some embodiments, a portion of the thermal power dissipated by the heater can contribute to heating of a thermally conductive solid article portion. In some embodiments, greater than or equal to 50%, greater than or equal to 60%, greater than or equal to 75%, greater than or equal to 90%, greater than or equal to 95% or more of the thermal power dissipated by the heater heats the thermally conductive solid article portion. In some embodiments, a portion of the thermal power dissipated by the heater can contribute to heating of the first electrochemical cell. In some embodiments, greater than or equal to 50%, greater than or equal to 60%, greater than or equal to 75%, greater than or equal to 90%, greater than or equal to 95% or more of the thermal power dissipated by the heater heats the first electrochemical cell.

In some embodiments, the stack of electrochemical cells is configured to maintain a temperature of at least a portion of the stack of electrochemical cells that exceeds an ambient temperature. In some cases, the ambient temperature is less than or equal to 10° C., less than 10° C., less than or equal to 5° C., less than or equal to 0° C., less than or equal to −10° C., less than or equal to −20° C., less than or equal to −30° C., or less. In some cases, the ambient temperature is greater than or equal to −90° C., greater than or equal to −70° C., greater than or equal to −40° C., greater than or equal to −20° C., or greater. In some cases, the stack of electrochemical cells is capable (e.g., at least in part due to the type and/or arrangement of the heater, thermally conductive solid article portion, and/or electrochemical cell within the stack) of maintaining a temperature of at least a portion of the stack of electrochemical cells of greater than or equal to 0° C., greater than or equal to 10° C., greater than or equal to 20° C., greater than or equal to 40° C., or greater. Combinations of these ranges are also possible. For instance, in some cases, the stack of electrochemical cells is capable of maintaining a temperature of at least a portion of the stack of electrochemical cells of greater than or equal to 10° C. at ambient temperatures of greater than or equal to −90° C. and less than 10° C. In some cases, the stack of electrochemical cells is capable of maintaining a temperature of at least a portion of the stack of electrochemical cells of greater than or equal to 10° C. at ambient temperatures of greater than or equal to −90° C. and less than 5° C.

In some embodiments, the stack of electrochemical cells is capable (e.g., at least in part due to the type and/or arrangement of the heater, thermally conductive solid article portion, and/or electrochemical cell within the stack) of maintaining a temperature of at least a portion (e.g., at least 10 vol %, at least 25 vol %, at least 50 vol %, at least 75 vol %, at least 90 vol %, at least 99 vol %, or all) of the stack of electrochemical cells of greater than or equal to 1° C. greater than an ambient temperature, greater than or equal to 5° C. greater than an ambient temperature, greater than or equal to 10° C. greater than an ambient temperature, greater than or equal to 20° C. greater than an ambient temperature, greater than or equal to 30° C. greater than an ambient temperature, greater than or equal to 50° C. greater than an ambient temperature, or greater. In some embodiments, the stack of electrochemical cells is capable of maintaining a temperature of at least a portion of the stack of electrochemical cells of up to 110° C. greater than an ambient temperature, up to 70° C. greater than an ambient temperature, up to 50° C. greater than an ambient temperature, or less. Combinations of these ranges are also possible. For instance, in some cases, the stack of electrochemical cells is capable of maintaining a temperature of at least a portion of the stack of electrochemical cells of between or equal to 1° C. and 110° C. greater than an ambient temperature or between or equal to 20° C. and 110° C. greater than an ambient temperature.

In some embodiments, the stack of electrochemical cells comprises a temperature sensor. For example, the stack of electrochemical cells may comprise a temperature sensor in thermal communication with a heater. The temperature sensor may be any of a variety of appropriate types of temperature sensors. In some embodiments the temperature sensor may be used to quantify temperature. For example, the temperature sensor may be a thermocouple or thermometer. However, the temperature sensor may sense temperature without quantifying temperature. For example, the temperature sensor may be a temperature-dependent resistor (e.g., a thermistor), a chromatic temperature indicator, or any of a variety of other temperature sensors. The temperature sensor may be introduced at any of a variety of positions within the stack of electrochemical cells. For example, the temperature sensor may be adjacent to a heater. As another example, the temperature sensor may be adjacent to a thermally conductive solid article portion. In some embodiments, the temperature sensor is part of a thermal spreader, as described in greater detail below.

In some embodiments, the temperature sensor can be used to adjust a rate of the heating. For example, the temperature sensor may be used to increase a heating rate. As another example, the temperature sensor may be used to decrease a heating rate. In some embodiments, the temperature sensor can be used to adjust a rate of the heating based, at least in part, on a temperature of a heater (e.g., based on the temperature of the heater used to heat a region of a thermally conductive solid article portion). In some embodiments, the temperature sensor can be used to adjust a rate of the heating based, at least in part, on a temperature of a thermally conducting solid article portion. The temperature sensor may be used to adjust a rate of the heating based, at least in part, on a temperature of a thermal spreader, as described in greater detail below. For example, a temperature sensor may be used to control a heater power. The sensor may indirectly control the heating rate, e.g., by providing information to an external controller or processor. However, in some embodiments the sensor directly controls the heating rate (e.g., by altering resistance of a circuit in response to a change in temperature). The use of a temperature sensor to control a rate of heating may create a feedback loop, that can, advantageously, regulate battery temperature towards a steady-state temperature. This may improve battery performance, in some embodiments.

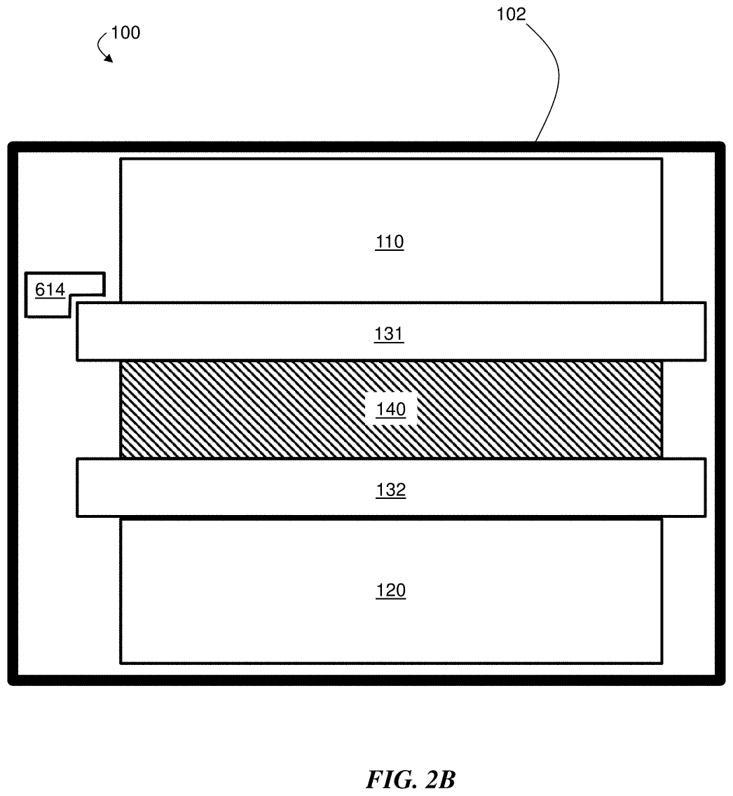

In some embodiments, the stack of electrochemical cells comprises a thermally conductive solid article portion. For example, referring back to FIGS. 2A-2B, stack of electrochemical cells 100 comprises first thermally conductive solid article portion 131 and second thermally conductive solid article portion 132. The thermally conductive solid article portion may promote heat transfer towards components of the stack of electrochemical cells (e.g., the electrochemical cells). In some embodiments, the thermally conductive solid article portion promotes heat transfer while also facilitating alignment of electrochemical active regions of the electrochemical cells. In some, but not necessarily all, cases, thermally conductive solid article portions are in direct contact with the electrochemical cells. For example, in FIGS. 2A-2B, first thermally conductive solid article portion 131 is shown as being in direct contact with first electrochemical cell 110. However, direct contact is not required, and in some embodiments, there are one or more intervening components (e.g., sensors, heaters, etc.) between the thermally conductive solid article portions and the electrochemical cells.

In some embodiments, the thermally conductive solid article portion of the stack of electrochemical cells has a relatively high effective thermal conductivity. As mentioned above, such a high effective thermal conductivity may allow the thermally conductive solid article to assist a heater with uniformly dissipating heat into one or more electrochemical cells of the stack of electrochemical cells. Thermal conductivity is generally understood to be an intrinsic property of a material related to its ability to conduct heat. Thermal conductivity is a temperature-dependent quantity and is typically reported in units of W m⁻¹ K⁻¹. The effective thermal conductivity of an article generally refers to the ability of an article to conduct heat, taking into account that the article may be made of a single material or may be a non-homogeneous material that may be made of a combination of materials (e.g., a composite material such as a particulate material or layered material). An exemplary method for measuring the thermal conductivity or effective thermal conductivity of a thermally conductive solid article portion is using a hot disk method, as described in ISO/DIS 22007-2.2.

In some embodiments, a thermally conductive solid article portion has a relatively high effective thermal conductivity in an in-plane direction. Referring again to FIG. 2A, for example, first thermally conductive solid article portion 131 and/or second thermally conductive solid article portion 132 may have a high effective thermal conductivity in lateral direction 151, which is parallel to the in-plane directions of first thermally conductive solid article portion 131 and/or second thermally conductive solid article portion 132. As a result, the thermally conductive solid article portion may enhance the rate at which heat is conducted from the heater to the first electrochemical cell, relative to the rate at which heat could be conducted from the heater to the first electrochemical cell if the thermally conductive solid article portion had a relatively low effective thermal conductivity in an in-plane direction. For instance, in FIG. 2A, first thermally conductive solid article portion 131 enhances the rate at which heat is conducted from heater 614 to first electrochemical cell 110. A resulting uniform heating of the first electrochemical cell may occur, and in combination with a reduced extent of heat transfer in the thickness direction can, in some instances, improve the safety and performance of the stack of electrochemical cells (e.g., by increasing the uniformity of current density throughout an electrochemical cell, and/or by increasing the capacity of an electrochemical cell). In some embodiments, a thermally conductive solid article portion (e.g., first thermally conductive solid article portion, second thermally conductive solid article portion) has an effective thermal conductivity of greater than or equal to 0.5 W m⁻¹ K⁻¹, greater than or equal to 1 W m⁻¹ K⁻¹, greater than or equal to 2 W m⁻¹ K⁻¹, greater than or equal to 5 W m⁻¹ K⁻¹, greater than or equal to 10 W m⁻¹ K⁻¹, greater than or equal to 25 W m⁻¹ K⁻¹, greater than or equal to 50 W m⁻¹ K⁻¹, greater than or equal to 65 W m⁻¹ K⁻¹, greater than or equal to 80 W m⁻¹ K⁻¹, greater than or equal to 100 W m⁻¹ K⁻¹, greater than or equal to 150 W m⁻¹ K⁻¹, greater than or equal to 159 W m⁻¹ K⁻¹, greater than or equal to 200 W m⁻¹ K⁻¹, greater than or equal to 250 W m⁻¹ K⁻¹, or greater in an in-plane direction at a temperature of 25° C. In some embodiments, a thermally conductive solid article portion (e.g., first thermally conductive solid article portion, second thermally conductive solid article portion) has an effective thermal conductivity of up to 300 W m⁻¹ K⁻¹, or greater in an in-plane direction at a temperature of 25° C. For example a thermally conductive solid article portion (e.g., first thermally conductive solid article portion, second thermally conductive solid article portion) may be made of aluminum metal and have an effective thermal conductivity of 159 W m⁻¹ K⁻¹ in an in-plane direction at a temperature of 25° C.

The thermally conductive solid article portion may comprise any of a variety of suitable materials. In some embodiments, a thermally conductive solid article portion (e.g., first thermally conductive solid article portion, second thermally conductive solid article portion) comprises a metal and/or metal alloy. Exemplary metals include, but are not limited to transition metals (e.g., titanium, manganese, iron, nickel, copper, zinc), non-transition metals (e.g., aluminum), and alloys or other combinations thereof. In certain embodiments, a thermally conductive solid article portion (e.g., first thermally conductive solid article portion, second thermally conductive solid article portion) comprises or is made of aluminum (aluminum metal or aluminum metal alloy), at least because aluminum has a relatively high effective thermal conductivity and a relatively low mass density, which in some cases contributes to an overall high specific energy density for a battery comprising the stack of electrochemical cells. One exemplary type of aluminum material of which a thermally conductive solid article portion may be made is 3003 H14 series aluminum, which is aluminum alloyed with 1.2% manganese to increase strength. In some embodiments, a relatively high percentage (e.g., greater than or equal to 50 weight percent (wt %), greater than or equal to 75 wt %, greater than or equal to 90 wt %, greater than or equal to 95 wt %, greater than or equal to 99 wt %, or more) of the thermally conductive solid article portion is metal and/or metal alloy.

In some embodiments, the thermally conductive solid article portion comprises or is made of a carbon-based material. Suitable carbon-based materials include, but are not limited to, graphite, carbon-fiber, graphene (e.g., as part of thermally conductive solid article comprising a solid substrate and associated with graphene), and combinations thereof. In some embodiments, the carbon-based material is present in a relatively high percentage (e.g., greater than or equal to 50 wt %, greater than or equal to 75 wt %, greater than or equal to 90 wt %, greater than or equal to 95 wt %, greater than or equal to 99 wt %, or more) of the thermally conductive solid article portion. In some embodiments, a carbon-based material of a thermally conductive solid article portion has graphite, carbon-fiber, graphene, or a combination thereof present in an amount of at least 25 wt %, at least 50 wt %, at least 75 wt %, at least 90 wt %, at least 95 wt %, at least 99 wt %, or 100 wt %. In some embodiments, the thermally conductive solid article portion comprises a composite comprising a carbon-based material (e.g., a carbon fiber composite).

The thermally conductive solid article portion may have any of a variety of form factors. In some embodiments, the thermally conductive solid article portion (e.g., first thermally conductive solid article portion, second thermally conductive solid article portion) is in the form of a relatively planar object (notwithstanding the non-planarities and/or alignment features described below). For example, the thermally conductive solid article portion (e.g., first thermally conductive solid article portion, second thermally conductive solid article portion) may be in the form of a sheet (e.g., a metal and/or metal alloy sheet). In some embodiments, the thermally conductive solid article portion (e.g., first thermally conductive solid article portion, second thermally conductive solid article portion) is or comprises a fin (e.g., a metal and/or metal alloy fin). In some embodiments, the thermally conductive solid article portion (e.g., first thermally conductive solid article portion, second thermally conductive solid article portion) is or comprises a solid plate. It should be understood that the surfaces of a sheet, fin, or solid plate do not necessarily need to be flat. For example, one of the sides of a sheet, fin, or solid plate could have any of the non-planarities and/or alignment features described herein.

The thermally conductive solid article portion (e.g., first thermally conductive solid article portion, second thermally conductive solid article portion) may have a thickness as well as two orthogonal lateral dimensions that are orthogonal to each other as well as orthogonal to the thickness. For example, referring to FIG. 2A, first thermally conductive solid article portion 131 has maximum thickness 235, lateral dimension 151, and a second lateral dimension (not pictured) orthogonal to both maximum thickness 235 and lateral dimension 151 (which would run into and out of the plane of the drawing in FIG. 2A).

The dimensions of the thermally conductive solid article portion may be chosen based on any of a variety of considerations. For example, the thickness or lateral dimensions may be chosen based on the desired total size of the stack of electrochemical cells and/or a desired pack burden for a battery comprising the stack of electrochemical cells. In some embodiments, one or more lateral dimensions of the thermally conductive solid article portion is such that heat generated by the heater, once conducted to the thermally conductive solid article portion, can be transferred a relatively long distance through the thermally conductive solid article portion before being conducted to the electrochemical cells. In some embodiments, the thermally conductive solid article portion has one or more lateral dimensions that extends at least 1 mm, at least 2 mm, at least 5 mm, at least 1 cm, at least 2 cm, at least 5 cm, and/or up to 10 cm or more past the electrochemical active region of the electrochemical cell coupled to the thermally conductive solid article portion.

In some embodiments, the thermally conductive solid article portion (e.g., first thermally conductive solid article portion, second thermally conductive solid article portion) has at least one lateral dimension that is at least 5 times, at least 10 times, and/or up to 20 times, up to 50 times, up to 100 times or more greater than the maximum thickness of the thermally conductive solid article portion.

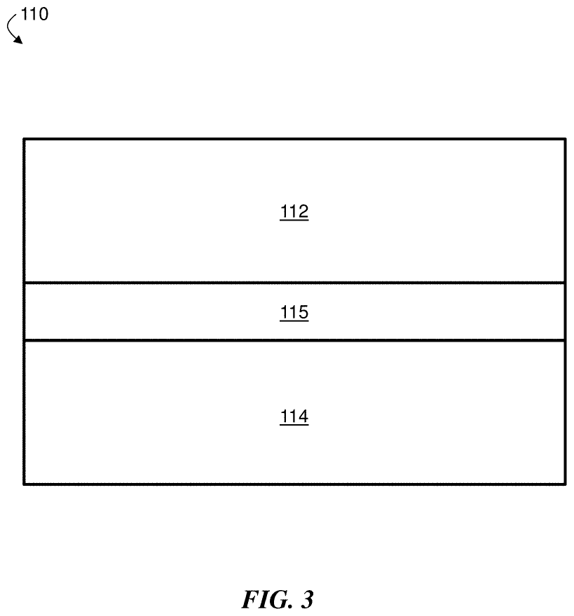

In some embodiments, electrochemical cells in the stack of electrochemical cells (e.g., the first electrochemical cell, the second electrochemical cell) comprise at least one anode. FIG. 3 shows a schematic diagram of one exemplary embodiment of first electrochemical cell 110 comprising anode 112. In some cases, the anode comprises an anode active material. As used herein, an “anode active material” refers to any electrochemically active species associated with an anode. In some embodiments, the anode comprises lithium metal and/or a lithium metal alloy as an anode active material. For example, referring again to FIG. 3, anode 112 comprises lithium metal and/or a lithium metal alloy as an anode active material in some embodiments. An electrode such as an anode can comprise, in accordance with certain embodiments, lithium metal and/or a lithium metal alloy as an electrode active material during at least a portion of or during all of a charging and/or discharging process of the electrochemical cell. In certain cases, the anode is or comprises vapor-deposited lithium (e.g., a vacuum-deposited lithium film). Additional suitable anode active materials are described in more detail below. Certain embodiments described herein may be directed to systems, devices, and methods that may allow for improved performance (e.g., magnitude and uniformity of applied force, thermal management, to promote uniformity of lithium deposition during charging) of electrochemical devices comprising certain anodes, such as lithium metal-containing anodes.

In some embodiments, electrochemical cells in the stack of electrochemical cells (e.g., the first electrochemical cell, the second electrochemical cell) comprise at least one cathode. For example, referring again to FIG. 3, first electrochemical cell 110 comprises cathode 114. The cathode can comprise a cathode active material. As used herein, a “cathode active material” refers to any electrochemically active species associated with a cathode. In certain cases, the cathode active material may be or comprise a lithium intercalation compound (e.g., a metal oxide lithium intercalation compound). As one non-limiting example, in some embodiments, cathode 114 in FIG. 3 comprises a nickel-cobalt-manganese lithium intercalation compound. Suitable cathode materials are described in more detail below.

As used herein, “cathode” refers to the electrode in which an electrode active material is oxidized during charging and reduced during discharging, and “anode” refers to the electrode in which an electrode active material is reduced during charging and oxidized during discharging.

In some embodiments, electrochemical cells in the stack of electrochemical cells (e.g., the first electrochemical cell, the second electrochemical cell) comprise a separator between the anode and the cathode. FIG. 3 shows exemplary separator 115 between anode 112 and cathode 114, according to certain embodiments. The separator may be a solid electronically non-conductive or insulative material that separates or insulates the anode and the cathode from each other, preventing short circuiting, and that permits the transport of ions between the anode and the cathode. In some embodiments, the separator is porous and may be permeable to an electrolyte.

It should be understood that while in some embodiments the first electrochemical cell and the second electrochemical cell have the same types of components (e.g., same anode active material, same cathode active material, same type of separator), in other embodiments the first electrochemical cell has one or more different components than the second electrochemical cell (e.g., a different anode active material, a different cathode active material, a different type of separator). In some embodiments, the first electrochemical cell and the second electrochemical cell are identical in composition and/or dimensions.

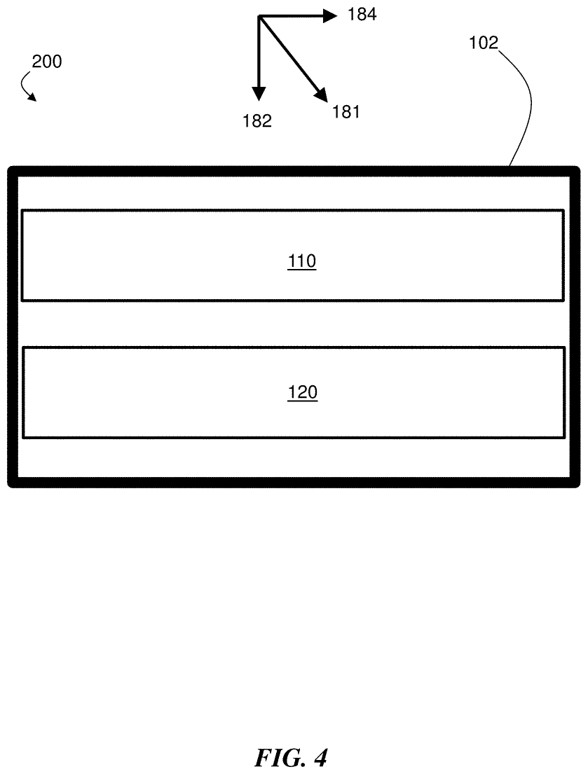

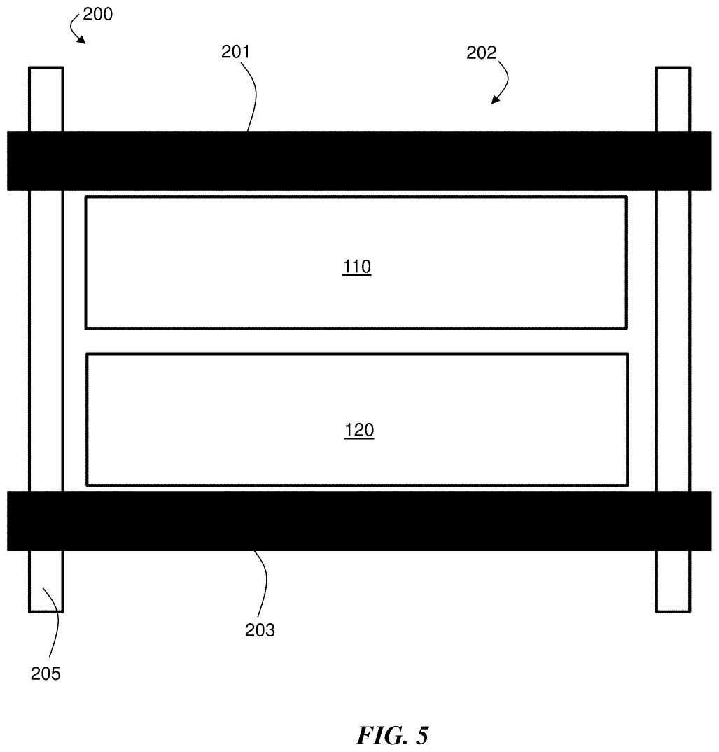

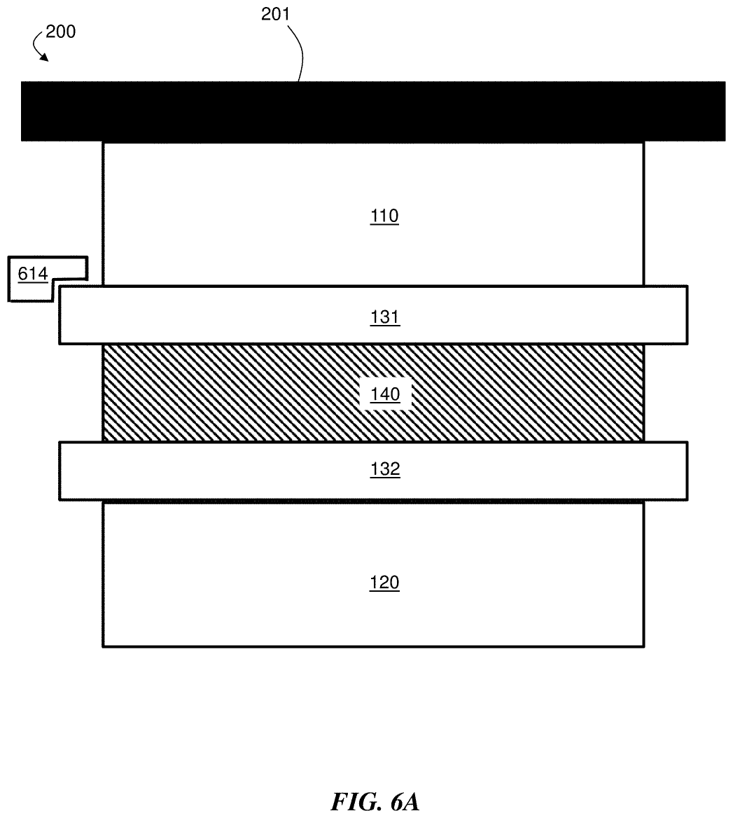

In some cases, the stack of electrochemical cells is part of a battery. In some embodiments, the battery comprises a housing that may at least partially enclose the stack of electrochemical cells and/or other components of the battery. For example, the housing may at least partially enclose the first electrochemical cell and the second electrochemical cell of the stack of electrochemical cells. FIG. 4 shows optional housing 102 at least partially enclosing first electrochemical cell 110 and second electrochemical cell 120 of battery 200, according to certain embodiments. The housing may comprise rigid components. As one example, the housing may comprise one or more solid plates. The solid plate may, for example, be an endplate. FIG. 5 shows a cross-sectional schematic diagram of exemplary battery 200 comprising housing 202, housing 202 comprising first solid plate 201 and second solid plate 203. Further details of certain solid plates that may be used in the battery are described below. In certain cases, the housing does not comprise a solid plate. For example, in some cases, the solid surface and other components of a containment structure configured to house the electrochemical device are part of a unitary structure.

In some embodiments, the battery comprises one or more solid plates. In some such cases, the housing is configured to apply the anisotropic force via a solid plate. The solid plates may be, for example, endplates configured to apply an anisotropic force to the electrochemical cells (e.g., first electrochemical cell, second electrochemical cell).

For example, in FIG. 5, first solid plate 201 and second solid plate 203 are endplates. It should be understood that the surfaces of a solid plate do not necessarily need to be flat. For example, one of the sides of the solid plate may comprise a surface that is curved (e.g., contoured, convex) in the absence of an applied force. In some embodiments, the solid plate (e.g., an aluminum solid plate) is convex with respect to the electrochemical cells in the absence of an applied force, and under at least one magnitude of applied force the end plate may become less convex (e.g., become flat).

The housing may comprise any suitable solid material. In some embodiments, a solid plate is or comprises a metal, metal alloy, composite material, or a combination thereof. In some cases, the metal that the solid plate is or comprises is a transition metal. For example, in some embodiments, the solid article is or comprises Ti, Cr, Mn, Fe, Co, Ni, Cu, or a combination thereof. In some embodiments, the solid plate is or comprises a non-transition metal. For example, in some embodiments, the solid article is or comprises Al, Zn, or combinations thereof. Exemplary metal alloys that the solid plate can be or comprise include alloys of aluminum, alloys of iron (e.g., stainless steel), or combinations thereof. Exemplary composite materials that the solid plate can be or comprise include, but are not limited to, reinforced polymeric, metallic, or ceramic materials (e.g., fiber-reinforced composite materials), carbon-containing composites, or combinations thereof.

In some embodiments, a solid plate (e.g., solid plate 201) of the housing comprises carbon fiber. Carbon fiber may be present in the solid plate in a relatively high amount (e.g., greater than or equal to 50 wt %, greater than or equal to 75 wt %, greater than or equal to 90 wt %, greater than or equal to 95 wt %, greater than or equal to 99 wt %, 100 wt %). Carbon fiber can, in some cases, afford relatively high stiffness and/or strength while having a relatively low mass (e.g., by having a relatively low mass density). It has been discovered, in the context of the present disclosure, that certain types of carbon fiber solid plates can allow for the application of relatively high magnitudes of anisotropic force to the electrochemical cells of the battery with relatively uniform distributions across multiple of the electrochemical cells without burdening the battery with too much mass. In some embodiments, the carbon fiber comprises unidirectional carbon fiber. In other words, in some embodiments, at least one layer (or all layers) of the carbon fiber material of the solid plate is unidirectional within the layer.

While relatively thin and/or twill weave carbon fiber materials are known, unidirectional carbon fiber laminates may afford relatively beneficial properties (e.g., high stiffness and/or strength, low deflection under load). In some embodiments, the housing comprises a solid plate comprising carbon fiber, the solid plate having a thickness of at least 5 mm, at least 8 mm, at least 10 mm, and/or up to 12 mm, up to 15 mm, up to 20 mm, or more.

The housing may comprise couplings that can be used to connect components of the housing and/or apply the anisotropic force. The housing may comprise, for example, couplings proximate to the ends of the housing (e.g., proximate to the ends of the solid plates). FIG. 5 shows coupling 205 connecting first solid plate 201 and second solid plate 203, according to certain embodiments. In some embodiments, the housing of the battery has more than one coupling. In certain cases, the housing includes at least 2 couplings, at least 4 couplings, and/or up to 8 couplings or more. In some embodiments, the coupling comprises a fastener. The fastener may span from one end of the housing to another. As one example, coupling 205 in FIG. 5 may be a fastener spanning from first solid plate 201 to second plate 203 of housing 202. Exemplary fasteners include, but are not limited to, a rod (e.g., a threaded rod, a rod with interlocking features), a bolt, a screw (e.g., a machine screw), a nail, a rivet, a tie, a clip (e.g., a side clip, a circlip), a band, or combinations thereof. In some cases, applying a force comprises causing relative motion between one portion of the coupling (e.g., a nut) and a fastener of the coupling (e.g., by tightening a nut at an interface between the fastener and the solid plate or, in cases where the fastener comprises a machine screw, by turning the machine screw).

In some embodiments, the battery has a relatively small volume. It has been discovered that certain aspects described herein, alone or in combination, such as the solid plates comprising carbon fiber, the thermally insulating compressible solid article portions, and the thermally conductive solid article portions, can allow for relatively high magnitudes of force and/or relatively high energy densities for the battery, even with a relatively small volume. In some embodiments, the battery has a volume of less than or equal to 15,000 cm³, less than or equal to 13,500 cm³, less than or equal to 12,000 cm³, less than or equal to 10,000 cm³, less than or equal to 8,000 cm³, less than or equal to 6,750 cm³, less than or equal to 6,000 cm³, less than or equal to 5,000 cm³, and/or as low as 4,000 cm³, or lower. As described in more detail below, certain configurations of the housing may provide for an ability to enclose a relatively large amount of electrochemical cell volume and/or apply relatively high force while having a relatively small housing volume.

In some embodiments, the battery has a relatively high energy density, as described above. In some embodiments, the battery has a specific energy of greater than or equal to 250 Wh/kg. In some embodiments, the battery has a specific energy of greater than or equal to 280 Wh/kg, greater than or equal to 290 Wh/kg, greater than or equal to 300 Wh/kg, and/or up to 320 Wh/kg, up to 350 Wh/kg, or more. In some embodiments, the battery has a volumetric density of greater than or equal to 230 Wh/L, greater than or equal to 250 Wh/L, greater than or equal to 280 Wh/L, and/or up to 300 Wh/L, or higher.

The battery may, surprisingly, have a relatively high energy density and/or apply a relatively high magnitude of force while having a relatively low pack burden (defined as one minus the mass of the electrochemical cells of the battery divided by the total mass of the battery). Expressed as an equation, pack burden=1−(mass of the electrochemical cells/mass of the battery). In some embodiments, the battery has a pack burden of less than or equal to 50%, less than or equal to 45%, less than or equal to 40%, less than or equal to 35%, less than or equal to 30%, and/or as low as 25%, as low as 20%, or lower.

As mentioned above, the battery may comprise components having a potentially advantageous arrangement (e.g., for thermal management). For example, in some embodiments, a stack of electrochemical cells is described comprising electrochemical cells, thermally conductive solid article portions, heaters, and optionally, thermally insulating compressible solid article portions. The stack of electrochemical cells may be part of a battery described herein. In some embodiments, a stack of electrochemical cells comprises the following in the order listed: a first electrochemical cell; a first thermally conductive solid article portion in thermal communication with a heater; optionally, a thermally insulating compressible solid article portion; a second thermally conductive solid article portion; and a second electrochemical cell. For example, referring to FIG. 1A, stack of electrochemical cells 100 comprises first electrochemical cell 110, first thermally conductive solid article portion 131 in thermal communication with heater 614, and second electrochemical cell 120. In FIG. 1C, an exemplary stack of electrochemical cells 100 comprises first electrochemical cell 110, first thermally conductive solid article portion 131 in thermal communication with heater 614, thermally insulating compressible solid article portion 140, and second electrochemical cell 120. This arrangement of heaters, thermally conductive components, and, optionally, thermally insulating components may facilitate relatively uniform transfer of heat towards electrochemical cells in the stack, while mitigating thermal transfer between electrochemical cells of the stack. For example, stack of electrochemical cells 100 may have a relatively low rate of thermal transfer in thickness direction 163 shown in FIG. 1A, while at least a portion of stack of electrochemical cells 100 may have a relatively high rate of thermal transfer in lateral direction 151 as shown in FIG. 1A.

Additionally, having one or more of the components be compressible may assist with mitigating expansion of the battery, e.g., during cumulative expansion of electrochemical cells during cycling. The stack may be at least partially enclosed by a housing. For example, stack of electrochemical cells 100 may be at least partially enclosed by optional housing 102 in FIG. 2B. In some, but not necessarily all embodiments, there are no intervening layers or components between these articles. For example, in some embodiments, the first electrochemical cell is directly adjacent to the first thermally conductive solid article portion, the first thermally conductive solid article portion is directly adjacent to the thermally insulating compressible solid article portion and is directly adjacent to the heater, and the thermally insulating compressible solid article portion is directly adjacent to the second electrochemical cell. However, in other embodiments, intervening articles or layers may be present, such as sensors (e.g., pressure sensors, temperature sensors, etc.). In some embodiments, at least one lateral edge of the thermally conductive solid article portion extends past a lateral edge of the first electrochemical cell. For example, in FIG. 2A an edge within region 156 of first thermally conductive solid article portion 131 extends past lateral edge 158 of first electrochemical cell 110, in accordance with certain embodiments. This may facilitate uniform heating of the electrochemical cells.

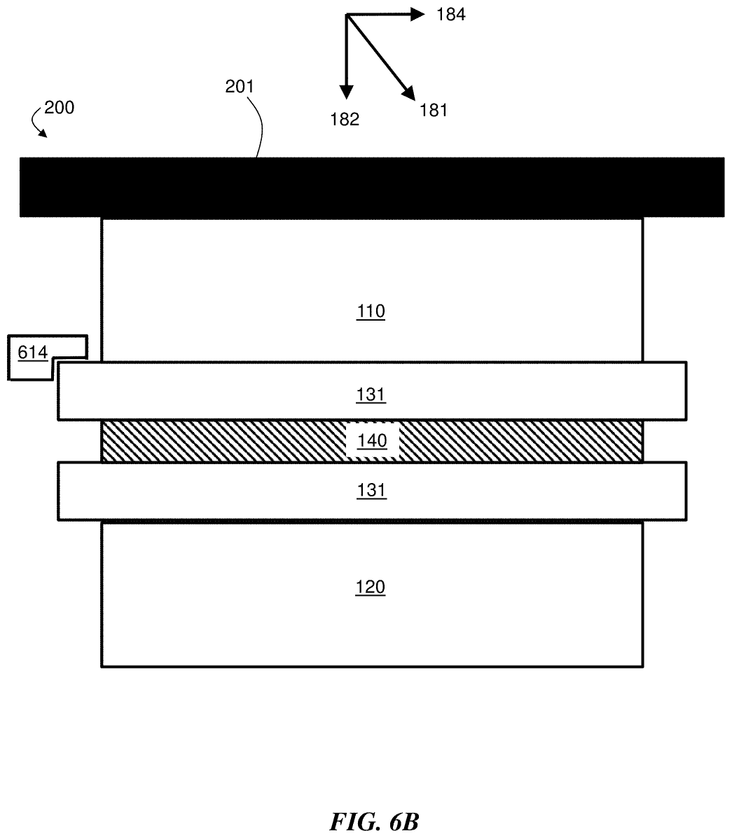

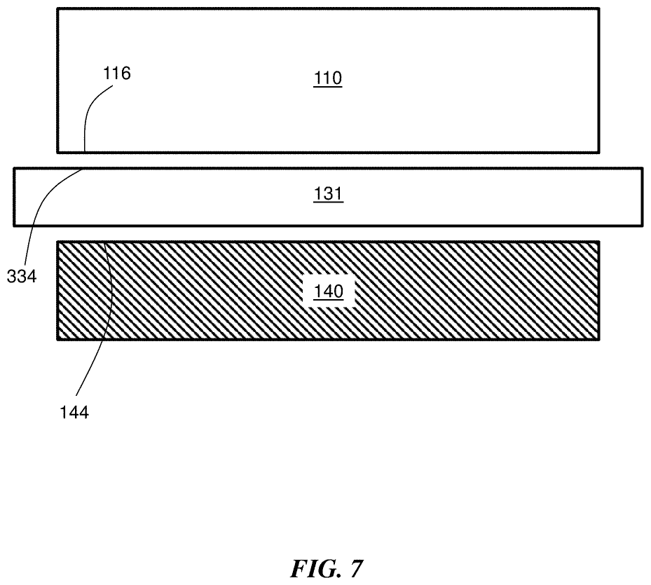

As mentioned below, some embodiments comprise application of an anisotropic force (e.g., via a solid plate). FIGS. 6A-6B show one such embodiment, where anisotropic force 181 is applied via first solid plate 201 (see FIG. 6B). FIG. 6B illustrates how in some embodiments, the application of such a force causes thermally insulating compressible solid article portion 140 to compress.

In some cases, it may be beneficial to apply force to electrochemical cells of a stack of electrochemical cells in a battery. For example, in some cases applying an anisotropic force with a component normal to at least one of the electrochemical cells can improve performance during charging and/or discharging by reducing problems such as dendrite formation and surface roughening of the electrode while improving current density. One such example is the case where at least one of the electrochemical cells of the battery comprises lithium metal or a lithium metal alloy as an electrode active material. Lithium metal may undergo dendrite growth, for example, which can in certain cases lead to failure of the electrochemical cell and safety hazards. Application of relatively high magnitudes of anisotropic force to electrodes comprising lithium metal may mitigate lithium dendrite formation and other deleterious phenomena. However, it has been realized in the context of the present disclosure that numerous challenges may emerge when applying force within batteries comprising multiple electrochemical cells (e.g., comprising lithium and/or lithium alloy as an electrode active material). For example, application of a relatively uniform force such that each of the electrochemical cells experiences a relatively similar pressure distribution can be important for performance and durability, and managing pressure on multiple cells must be accomplished simultaneously. Further, certain types of electrochemical cells may undergo relatively large dimensional changes during cycling. As one example, an electrode comprising lithium and/or lithium metal alloy may expand significantly due to lithium deposition during charging and contract significantly upon lithium ion release during discharging. Such dimensional changes of the electrochemical cells may lead to uneven pressure distributions and problematic battery pack dimensional changes.

Some embodiments are related to applying, during at least one period of time during charge and/or discharge of the electrochemical cells (e.g., first electrochemical cell, second electrochemical cell), an anisotropic force with a component normal to an electrode active surface of at least one electrochemical cell of the stack of electrochemical cells. As mentioned above, application of such a force may reduce potentially deleterious phenomena associated with certain types of electrochemical cells (e.g., cells comprising lithium metal as an electrode active material) and improve utilization. For example, in some cases, applying an anisotropic force with a component normal to an active surface of an electrode of the electrochemical device can reduce problems (such as surface roughening of the electrode and dendrite formation) while improving current density. Application of such forces to multiple electrochemical cells of a stack of electrochemical cells pack may present certain challenges, including uniformity of pressure distribution for each electrochemical cell, which can be important for both performance and durability. Certain aspects described herein may, in some cases, address and overcome such challenges.

FIG. 4 depicts a schematic cross-sectional illustration of a force that may be applied to the first electrochemical cell and the second electrochemical cell in the direction of arrow 181. Arrow 182 illustrates the component of force 181 that is normal to an active surface of first electrochemical cell 110, according to certain embodiments.

In some embodiments, a housing of a battery comprising a stack of electrochemical cells is configured to apply, during at least one period of time during charge and/or discharge of the first electrochemical cell and/or the second electrochemical cell, an anisotropic force having a relatively high magnitude component normal to electrode active surfaces of at least one (or all) of the electrochemical cells in the battery. For example, in some embodiments where the battery comprises a first electrochemical cell having a first electrode active surface and a second electrochemical cell having a second electrode active surface, the housing of the battery is configured to apply, during at least one period of time during charge and/or discharge of the first electrochemical cell and/or the second electrochemical cell, an anisotropic force having a relatively high magnitude component normal to the first electrode active surface and the second electrode active surface. The housing may be configured to apply such a force in a variety of ways. For example, in some embodiments, the housing comprises two solid articles (e.g., a first solid plate and a second solid plate as shown in FIG. 5, where housing 202 comprises first solid plate 201 and second solid plate 203). An object (e.g., a machine screw, a nut, a spring, etc.) may be used to apply the force by applying pressure to the ends (or regions near the ends) of the housing. In the case of a machine screw, for example, the electrochemical cells and other components of the battery may be compressed between the plates (e.g., a first solid plate and a second solid plate) upon rotating the screw. As another example, in some embodiments, one or more wedges may be displaced between the housing and a fixed surface (e.g., a tabletop, etc.). The force may be applied by driving the wedge between the housing (e.g., between a solid plate of a containment structure of the housing) and the adjacent fixed surface through the application of force on the wedge (e.g., by turning a machine screw).

Some embodiments comprise applying an anisotropic force with a component normal to a first electrode active surface of the first electrochemical cell and/or a second electrode active surface of the second electrochemical cell defining a pressure of at least 10 kgf/cm², at least 12 kgf/cm², at least 20 kgf/cm², at least 25 kgf/cm², or more. In some such cases, the housing is configured to apply such anisotropic forces. While high magnitudes of anisotropic force with a component normal to an electroactive surface can improve performance, too high of a magnitude of force may cause problems such as damage to certain components of the battery (e.g., the thermally insulating compressible solid article portion described below). It has been unexpectedly observed, however, that there are ranges of magnitudes of anisotropic force that can be applied that can, in some cases, achieve desirable performance of the battery while avoiding such damage. For example, some embodiments comprise applying (e.g., via the housing) during at least one period of time during charge and/or discharge of the first electrochemical cell and/or the second electrochemical cell, an anisotropic force with a component normal to a first electrode active surface of the first electrochemical cell and/or a second electrode active surface of the second electrochemical cell defining a pressure of less than or equal to 40 kgf/cm², less than or equal to 35 kgf/cm², less than or equal to 30 kgf/cm², or less.

Combinations of these ranges (e.g., at least 10 kgf/cm² and less than or equal to 40 kgf/cm², or at least 12 kgf/cm² and less than or equal to 30 kgf/cm²) are possible.

Some embodiments comprise applying a first anisotropic force with a component normal to a first electrode active surface of the first electrochemical cell and/or a second electrode active surface of the second electrochemical cell defining a pressure having a first magnitude of at least 10 kgf/cm² (e.g., at least 12 kgf/cm²), and then also during a charge and/or discharge of the battery, applying a second anisotropic force with a component normal to a first electrode active surface of the first electrochemical cell and/or a second electrode active surface of the second electrochemical cell defining a pressure having a second magnitude that is at least 10 kgf/cm², at least 12 kgf/cm², or higher and less than or equal to 40 kgf/cm², less than or equal to 30 kgf/cm², or less. In some embodiments, the second magnitude of pressure is greater than the first magnitude by a factor of at least 1.2, at least 1.5, at least 2, at least 2.5, and/or up to 3, or up to 4. The second magnitude may be higher than the first magnitude, for example, in some embodiments where the first magnitude of force is applied via the housing (e.g., a rigid housing) and during a charging and/or discharge process, expansion of one or more components of the battery (e.g., one or more electrochemical cells) causes the force experienced by the electrochemical cells to increase. In some embodiments, the first magnitude occurs when the electrochemical cells are at a state of charge (SOC) of less than or equal to 10%, less than or equal to 5%, less than or equal to 2%, less than or equal to 1%, or 0%. In some embodiments, the second magnitude occurs when the electrochemical cells are at a state of charge of greater than or equal to 50%, greater than or equal to 75%, greater than or equal to 90%, greater than or equal to 95%, greater than or equal to 99%, or 100%. Combinations of these ranges are possible. For example, in some embodiments, the first magnitude occurs when the electrochemical cells are at a state of charge of less than or equal to 10% and the second magnitude (e.g., that defines a pressure that is greater than that of the first magnitude by a factor of at least 1.2 and up to 4) occurs when the electrochemical cells are at a state of charge of greater than or equal to 50%. In some exemplary embodiments, the magnitude of the anisotropic force defines a pressure of greater than or equal to 10 kgf/cm² and less than or equal to 40 kgf/cm². In some embodiments, the magnitude of anisotropic force defines a pressure of 10 kgf/cm² at a 0% SOC and 40 kgf/cm² at a 100% SOC. In one exemplary embodiment, the magnitude of anisotropic force defines a pressure of 12 kgf/cm² at a 0% SOC and 30 kgf/cm² at a 100% SOC.

In some embodiments, the stack of electrochemical cells comprises a thermally insulating compressible solid article portion. In some aspects, the thermally insulating compressible solid article portion can compensate for dimensional changes of components of a stack of electrochemical cells while also limiting heat transfer between electrochemical cells. The thermally insulating compressible solid article portion may be between two electrochemical cells of the stack of electrochemical cells. For example, referring back to FIGS. 2A-2B, stack of electrochemical cells 100 comprises thermally insulating compressible solid article portion 140 between first electrochemical cell 110 and second electrochemical cell 120, according to certain embodiments. A more detailed description of exemplary thermally insulating compressible solid article portions is described below.

In some embodiments, the thermally conductive solid article portion is relatively smooth as compared to the thermally insulating compressible solid article portion. This may, in some cases, be advantageous, because, under high magnitudes of force, surface irregularities in certain types of thermally insulating compressible solid article portions (e.g., microcellular foams) may cause non-uniform pressure distributions on the electrode active surfaces of the stack of electrochemical cells. A relatively smooth thermally conductive solid article portion (e.g., a metal sheet) may, comparatively, have few irregularities and “smooth” out the pressure distribution. As one example, in FIG. 7, surface 144 of thermally insulating compressible solid article portion 140 may be relatively rough (e.g., have a relatively high surface roughness), while surface 334 of first thermally conductive solid article portion 131 may be relatively smooth (e.g., have a relatively low surface roughness), thereby mitigating irregularities in pressure distribution to surface 116 of first electrochemical cell 110. In some embodiments, the thermally conductive solid article portion has a surface facing a surface of the first electrochemical device having a surface roughness of less than or equal to 10 micrometers, less than or equal to 5 micrometers, less than or equal to 1 micrometer, less than or equal to 0.5 micrometers, less than or equal to 0.1 micrometers, less than or equal to 0.05 micrometers, less than or equal to 0.01 micrometers, or less. In some embodiments, the thermally conductive solid article portion has a surface facing a surface of the first electrochemical device having a surface roughness as low as 0.005 micrometers. That is to say, in some embodiments, the thermally conductive solid article portion has a surface having a surface roughness as low as 0.005 micrometers, with that surface facing a surface of the first electrochemical device.

The thermally insulating compressible solid article portion may take any of a variety forms. For example, the thermally insulating compressible solid article portion may be in the form of a solid block, a foam sheet, a mesh, or any other suitable form, provided that it be thermally insulating and compressible. It should be understood that while the thermally insulating compressible solid article portion is referred to as a solid article, it may be at least partially hollow and/or contain pores or voids.

In some embodiments, the thermally insulating compressible solid article portion is a unitary object. FIGS. 2A-2B depict thermally insulating compressible solid article portion 140 as a unitary object (e.g., a single sheet of foam), as one example. It should be understood that a thermally insulating compressible solid article portion that is a unitary object may be part of a larger article in some instances. In some embodiments, the thermally insulating compressible solid article portion comprises multiple separate objects. For example, the thermally insulating compressible solid article portion may comprise multiple layers (e.g., sheets) of either the same or different materials (e.g., foams) as a stack or otherwise arranged. For the properties described herein (e.g., uncompressed thickness, compression set, compressive stress versus percent compression, thermal conductivity, etc.), the measured values correspond to the entirety of the thermally insulating compressible solid article portion. For example, if the thermally insulating compressible solid article portion is a unitary object, the parameters correspond to that unitary object. In instances where the thermally insulating compressible solid article portion comprises multiple separate objects (e.g., a stack of foam sheets), the parameters of the thermally insulating compressible solid article portion correspond to that of the aggregate of all the separate objects of that portion (e.g., all foam sheets measured together as a stack).

In some embodiments, the thermally insulating compressible solid article portion comprises a foam. A foam solid article generally refers to a solid containing pockets of (“cells”) capable of being occupied by a fluid. The pockets may be present throughout the dimensions of the solid. The foam may be present as a relatively high percentage of the thermally insulating compressible solid article portion (e.g., greater than or equal to 50 weight percent (wt %), greater than or equal to 75 wt %, greater than or equal to 90 wt %, greater than or equal to 95 wt %, greater than or equal to 99 wt %, or more). The use of thermally insulating compressible solid article portions comprising a relatively large amount of foam may, in some cases, contribute to a relatively high compressibility of the thermally insulating compressible solid article portion. For example, referring back to FIG. 2A, in certain embodiments in which thermally insulating compressible solid article portion 140 has a relatively high foam content, pressure experienced by stack of electrochemical cells 100 may result in a relatively large compression of thermally insulating compressible solid article portion 140.

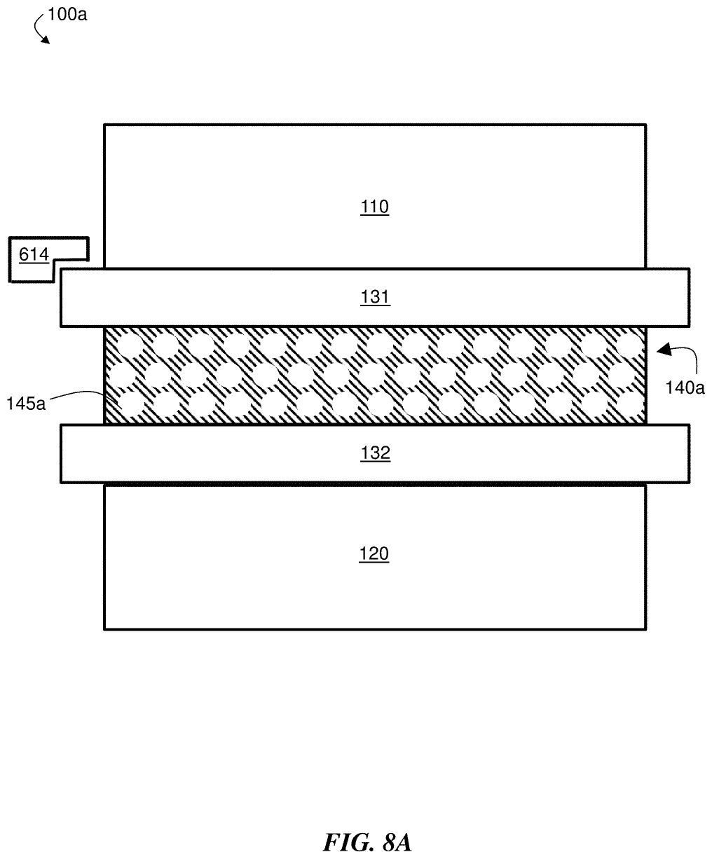

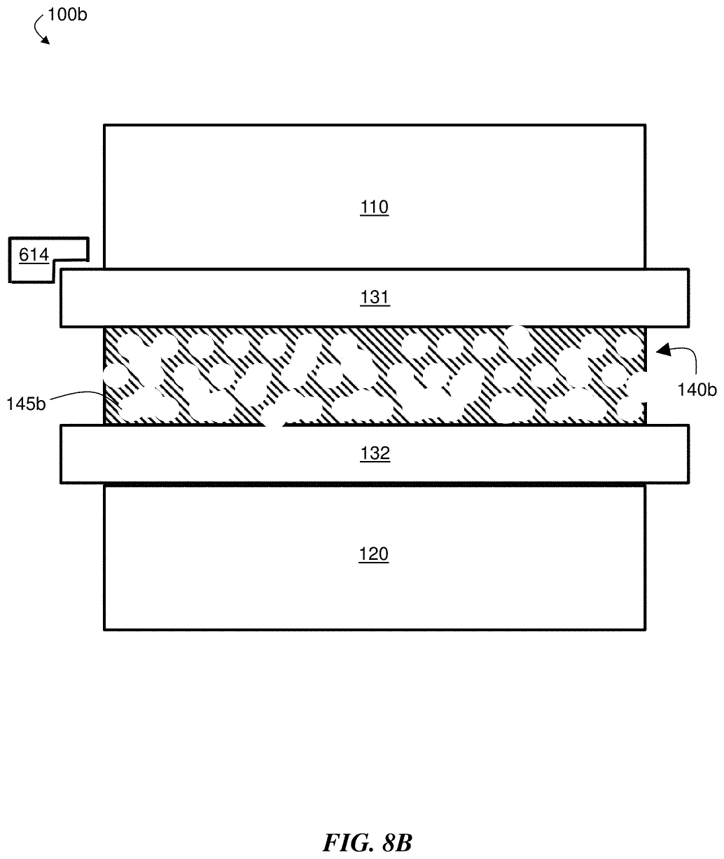

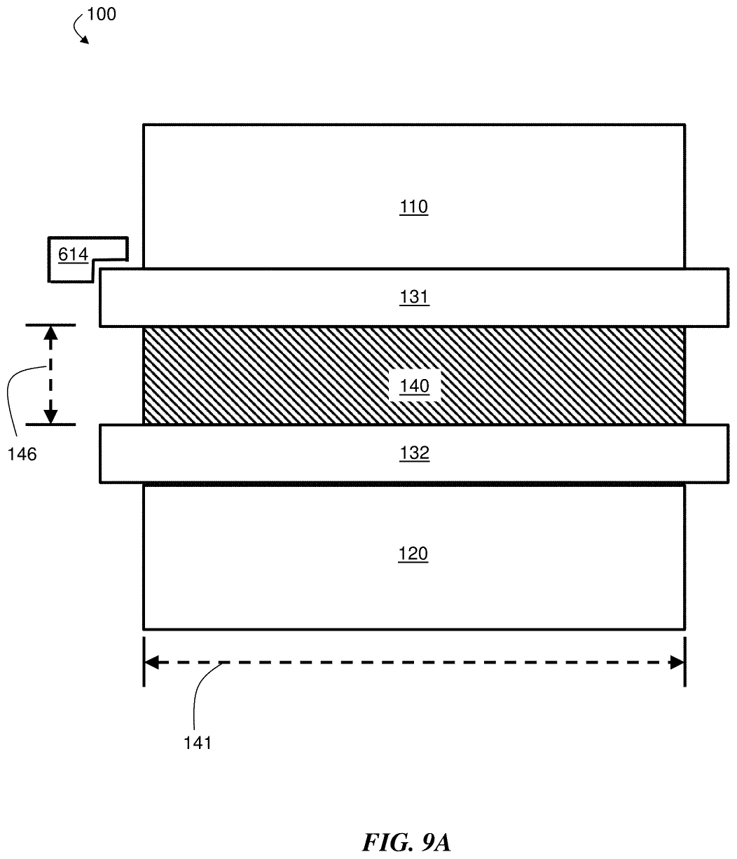

In some embodiments, the thermally insulating compressible solid article portion is or comprises a closed-cell foam. A closed-cell foam solid generally refers to a foam comprising cells (gas pockets) that are discrete and completely surrounded by the solid material of the foam. FIG. 8A shows one such example, where thermally insulating compressible solid article portion 140a of stack of electrochemical cells 100a is a closed-cell foam comprising discrete cells 145a.

However, in some embodiments, the thermally insulating compressible solid article portion is or comprises an open-cell foam. An open-cell foam solid generally refers to a foam comprising cells connected to each other, thereby allowing for a gas or other fluid to travel from cell to cell. FIG. 8B shows one such example, where thermally insulating compressible solid article portion 140b of stack of electrochemical cells 100b is an open-cell foam comprising connected cells 145b.

In some embodiments, a thermally insulating compressible solid article portion comprises a microcellular foam. A microcellular foam generally refers to a foam whose cells have an average largest cross-sectional dimension on the order of microns (e.g., greater than or equal to 0.1 micron, greater than or equal to 1 micron, and/or up to 50 microns, up to 100 microns, or up to 500 microns). For example, in embodiments in which thermally insulating compressible solid article portion 140 in FIG. 8A is a microcellular foam, cell 145a may have a largest cross-sectional dimension of between 0.1 and 500 microns. Microcellular foams are typically made of polymeric materials (e.g., plastics) and can be prepared, for example by dissolving gases under high pressure into the material from which the foam is made. Foams such as microcellular foams may be useful in some instances in which thermally insulating compressible solid article portions having a relatively low mass density are desired. A low-density thermally insulating compressible solid article portion may contribute at least in part to a battery having a high specific energy density. In some embodiments, the density of the thermally-insulating compressible solid article portion is variable. For example, in some embodiments, regions occupying at least 0.5%, at least 1%, at least 2%, at least 5%, at least 10%, or more of the external geometric volume of the thermally insulating compressible solid article portion have a density (mass density) that is at least 5%, at least 10%, at least 25%, at least 50%, at least 75%, at least 90%, at least 95%, or at least 99% lower than an overall average density of the thermally insulating compressible solid article portion (which can be calculating by dividing the mass of the overall thermally insulating compressible solid article by the overall uncompressed volume of the thermally insulating compressible solid article). One non-limiting way of achieving such variance in density is by including holes/gaps in the thermally insulating compressible article portion such that the overall external geometric dimensions of the thermally insulating solid article portion are suitable for performing some or all of the roles described herein, while a mass of the thermally insulating compressible solid article is reduced. It has been observed that some such configurations may provide for a relative reduction in the mass of the battery (and an increase in energy density) without significantly affecting performance of the battery. Further, it has also been observed that some such configurations may provide for relatively uniform pressure distribution experienced by one or more electrochemical cells of the battery is relatively uniform, at least because the density of region of a thermally compressible solid article may affect a magnitude of force experienced by an electrochemical cell adjacent to that region.

In some embodiments, the thermally insulating compressible solid article portion comprises a mesh. As an example, in certain instances, the thermally insulating compressible solid article portion is a mesh structure made of strands of flexible, thermally-insulating material (e.g., fiber, plastic) that are attached and/or woven together. As a thermal insulator, the thermally insulating compressible solid article portion may contribute at least in part to advantageous thermal management of components of the battery. In some embodiments, the thermally insulating compressible solid article portion has a relatively low effective thermal conductivity (consequently making it a relatively good thermal insulator). The thermal insulating capability of the thermally insulating compressible solid article portion can, in some cases, contribute at least in part to thermally isolating one or more electrochemical cells and the battery from one or more other portions of the battery. For example, referring back to FIGS. 2A-2B, in some embodiments in which thermally insulating compressible solid article portion 140 has a relatively low effective thermal conductivity, thermally insulating compressible solid article portion 140 mitigates heat transfer between first electrochemical cell 110 and second electrochemical cell 120. Such a mitigation in heat transfer can, in some instances, reduce propagation of deleterious phenomena among the electrochemical cells (e.g., during cycling).

In some embodiments, the thermally insulating compressible solid article portion has a relatively low effective thermal conductivity in the thickness direction. Referring again to FIG. 2A, for example, thermally insulating compressible solid article portion 140 may have a low effective thermal conductivity in thickness direction 153. As a result, thermally insulating compressible solid article portion 140 may reduce the rate at which heat is transferred from first electrochemical cell 110, through thermally insulating compressible solid article portion 140 in thickness direction 153, and to second electrochemical cell 120, according to certain embodiments. This reduced extent of heat transfer in the thickness direction can, in some instances, improve the safety and performance of the battery (e.g., by reducing thermal propagation). In some embodiments, the thermally insulating compressible solid article portion has an effective thermal conductivity of less than or equal to 0.5 W m⁻¹ K⁻¹, less than or equal to 0.25 W m⁻¹ K⁻¹, and/or as low as 0.1 W m⁻¹ K⁻¹, as low as 0.01 W m⁻¹ K⁻¹, or less in the thickness direction at a temperature of 25° C. For example, the thermally insulating compressible solid article portion may comprise a microcellular foam and have an effective thermal conductivity of 0.21 W m⁻¹ K⁻¹ in the thickness direction at a temperature of 25° C. In some embodiments, the rate of heat transfer between two components of the battery (e.g., first electrochemical cell 110 and second electrochemical cell 120 in FIGS. 2A-2B) is relatively low. In certain cases, the rate of heat transfer from the first electrochemical cell to the second electrochemical cell is less than or equal to 5 W m⁻¹ K⁻¹, less than or equal to 2.5 W m⁻¹ K⁻¹, and/or as low as 1 W m⁻¹ K⁻¹, as low as 0.1 W m⁻¹ K⁻¹, or less when the temperature difference between the first electrochemical cell and the second electrochemical cell is 10 K.

The compressibility of the thermally insulating compressible solid article portion may be useful in any of a variety of applications. As one example, in some instances in which one or more components of the battery change dimension during a charging and/or discharge process, a resulting compression of the thermally insulating compressible solid article portion may compensate for that change in dimension. In some such cases, the compressibility of the thermally insulating compressible solid article portion under stress may reduce the extent to which a battery expands or contracts when electrochemical cells within the battery undergo expansion and/or contraction during cycling.

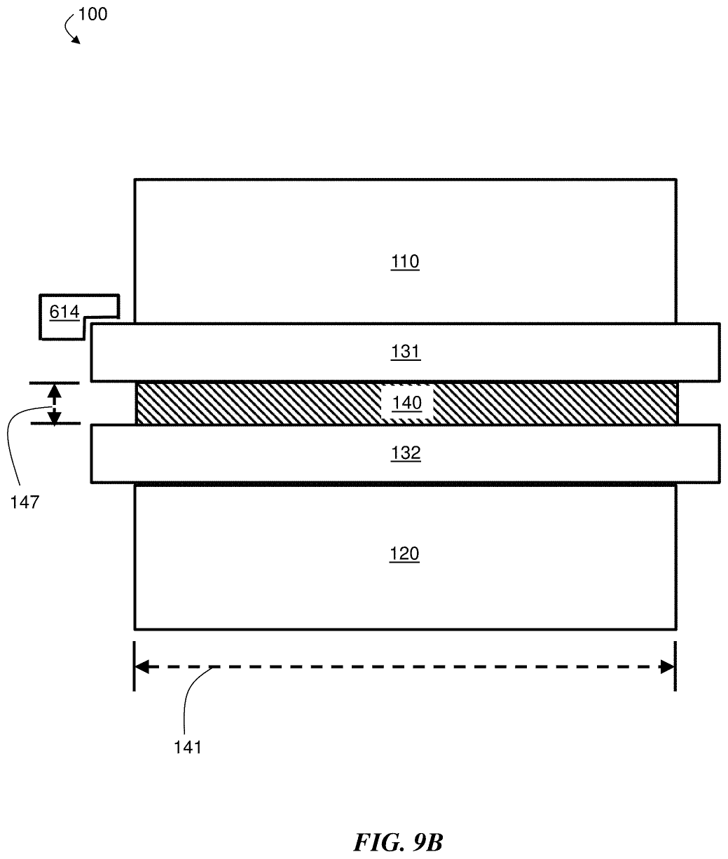

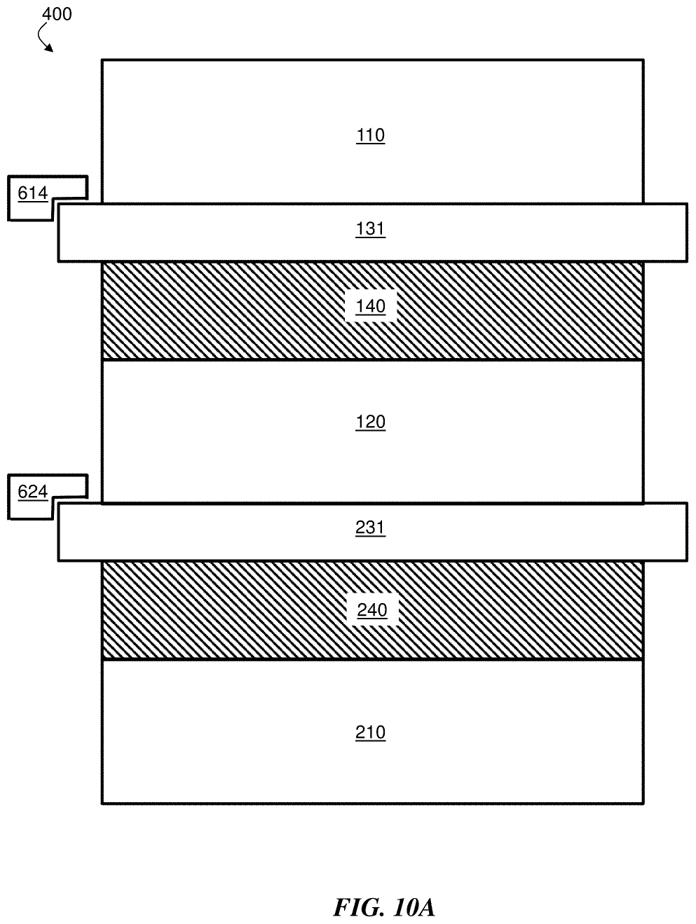

FIGS. 9A-9B show cross-sectional schematic diagrams of stack of electrochemical cells 100 of a battery in the absence (FIG. 9A) and presence (FIG. 9B) of an anisotropic force in the direction of arrow 481, with a component 482 normal to an electrochemical cell. The anisotropic force in the direction of arrow 481 may also have a component 484 parallel to an electrochemical cell. As described above, in some cases, at least a portion of the anisotropic force is applied by a pressure device such as solid plate (e.g., an endplate). In some instances, at least a portion of the anisotropic force is caused by a change in dimension (e.g., expansion) of one or more components of the battery. For example, in some cases a charging process of the battery causes one or more electrochemical cells (e.g., the first electrochemical cell, the second electrochemical cell) to expand in a thickness direction. One such example is in certain cases where a lithium metal and/or a lithium metal alloy is used as an anode active material, and lithium deposition on the anode occurs during charging.

In some embodiments, the application of force to the thermally insulating compressible solid article portion (e.g., via the first electrochemical cell and/or the second electrochemical cell or an intervening battery component) causes the thermally insulating compressible solid article portion to compress in the thickness direction.

Referring again to FIGS. 9A-9B, for example, thermally insulating compressible solid article portion 140 may have uncompressed thickness 146 in the absence of an applied anisotropic force (as shown in FIG. 9A) and smaller compressed thickness 147 when anisotropic force 481 is applied and/or when expansion of first electrochemical cell 110 and/or second electrochemical cell 120 occurs.

In some embodiments, the thermally insulating compressible solid article portion has a relatively low uncompressed mass density. A low mass density may contribute, at least in part, to the battery having a relatively high specific energy density. The uncompressed mass density of the thermally insulating compressible solid article portion refers to the bulk mass per unit volume of the article portion in the absence of a load (e.g., compressive stress). In some embodiments, the thermally insulating compressible solid article portion has an uncompressed mass density of greater than or equal to 0.3 g/cm³, greater than or equal to 0.35 g/cm³, greater than or equal to 0.4 g/cm³, greater than or equal to 0.45 g/cm³, greater than or equal to 0.5 g/cm³, and/or up to 0.55 g/cm³, up to 0.6 g/cm³, up to 0.65 g/cm³, up to 0.7 g/cm³, or greater at 25° C.

The thermally insulating compressible solid article portion can be made of any of a variety of suitable materials, provided that it have one or more of the combinations of thermal and mechanical properties in the present disclosure. In some embodiments, the thermally insulating compressible solid article portion comprises a polymeric material. A relatively large percentage of the thermally insulating compressible solid article portion may be made of a polymeric material. For example, greater than or equal to 50 wt %, greater than or equal to 75 wt %, greater than or equal to 90 wt %, greater than or equal to 95 wt %, greater than or equal to 99 wt %, or more (e.g., 100 wt %) of the thermally insulating compressible solid article portion may be made of a polymeric material. In certain embodiments, the thermally insulating compressible solid article portion comprises a polymeric foam, such as a microcellular polymeric foam. While any of a variety of polymeric materials may be suitable, in certain instances the thermally insulating compressible solid article portion comprises a relatively elastic polymer. In some embodiments, the thermally insulating compressible solid article portion is or comprises an elastomer. As one non-limiting example, the thermally insulating compressible solid article portion may comprise a polyurethane. Polyurethanes are polymers comprising organic repeat units linked by carbamate (urethane) units. Polyurethanes can be made using any of a variety of techniques, such as by reacting isocyanates and polyols. In some embodiments, the thermally insulating compressible solid article portion is or comprises a microcellular polyurethane foam (e.g., foam sheet or foam layer). Referring to FIG. 2A, for example, stack of electrochemical cells 100 may comprise first electrochemical cell 110, second electrochemical cell 120, and thermally insulating compressible solid article portion 140 between first electrochemical cell 110 and second electrochemical cell 120, where thermally insulating compressible solid article portion 140 is an elastomeric microcellular foam layer or sheet made of polyurethane. One non-limiting example of an elastomeric microcellular polyurethane foam that can be used as a thermally insulating compressible solid article portion is sold by BASF under the trade name Cellasto®.

The thermally insulating compressible solid article may have a thickness as well as two orthogonal lateral dimensions that are orthogonal to each other as well as orthogonal to the thickness. For example, referring to FIG. 9A, thermally insulating compressible solid article portion 140 has thickness 146, lateral dimension 141, and a second lateral dimension (not pictured) orthogonal to both thickness 146 and lateral dimension 141 (which would run into and out of the plane of the drawing in FIG. 9A). As mentioned above, the thermally insulating compressible solid article may have an uncompressed thickness (e.g., uncompressed thickness 146 in FIG. 9A) and a compressed thickness (e.g., compressed thickness 147 FIG. 9B), with the latter depending in some cases on the magnitude of an applied force.

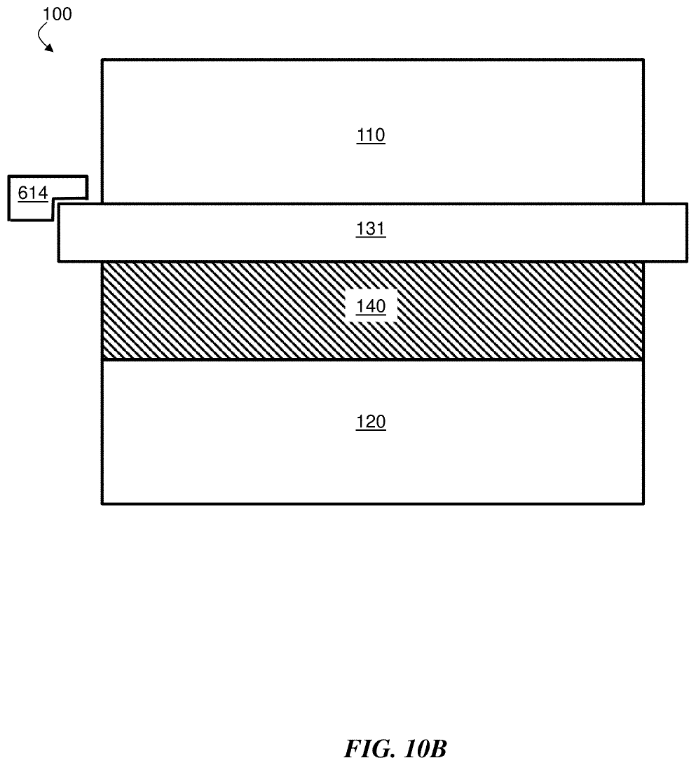

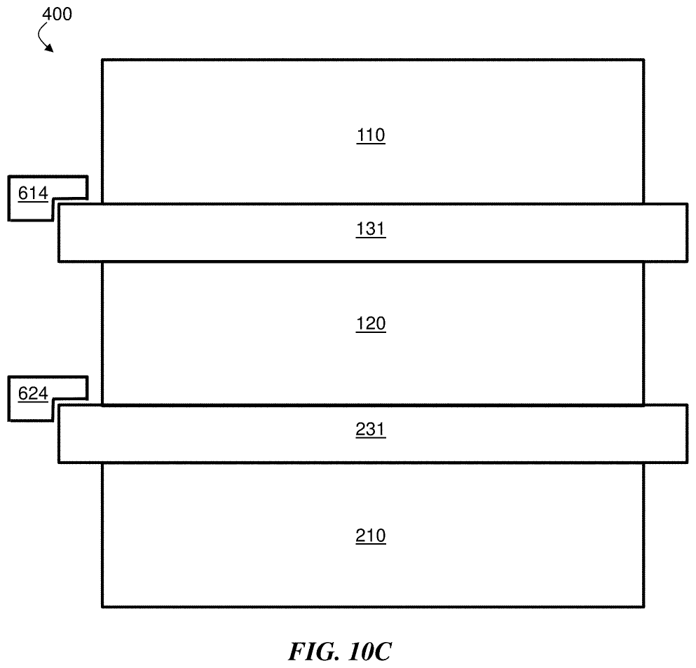

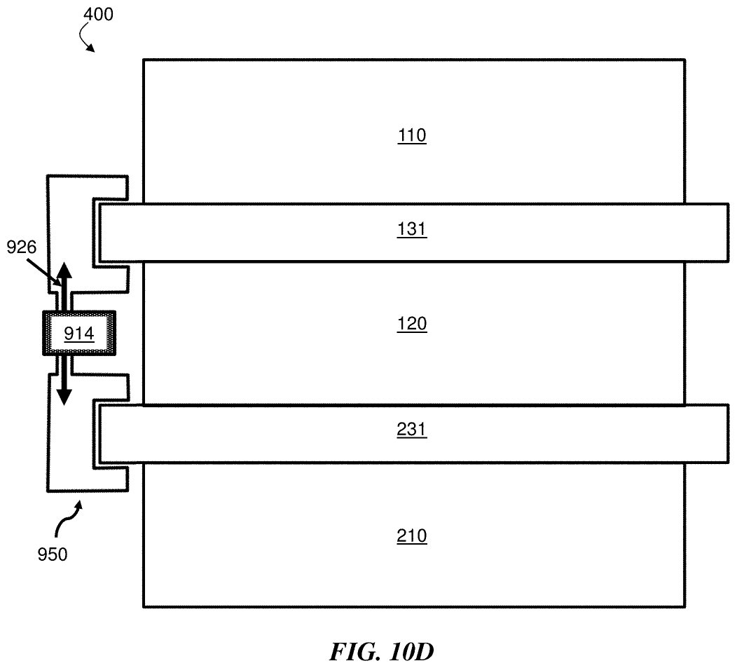

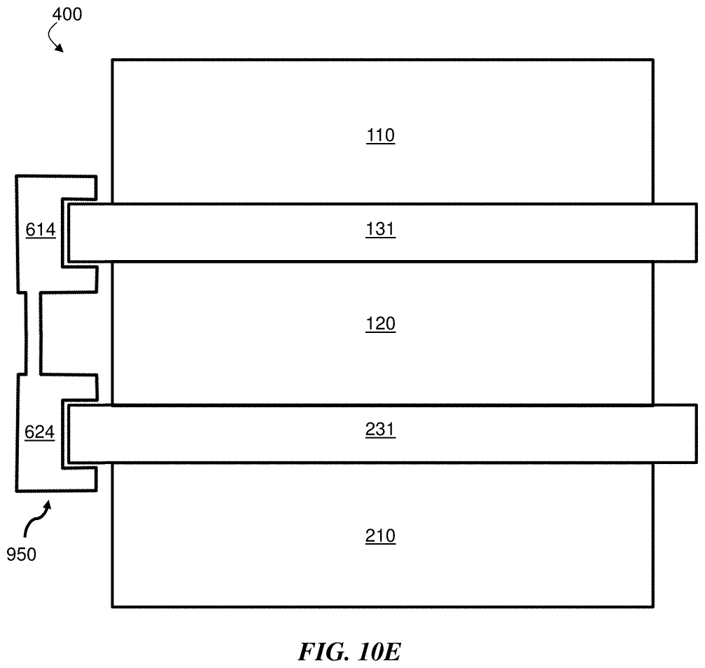

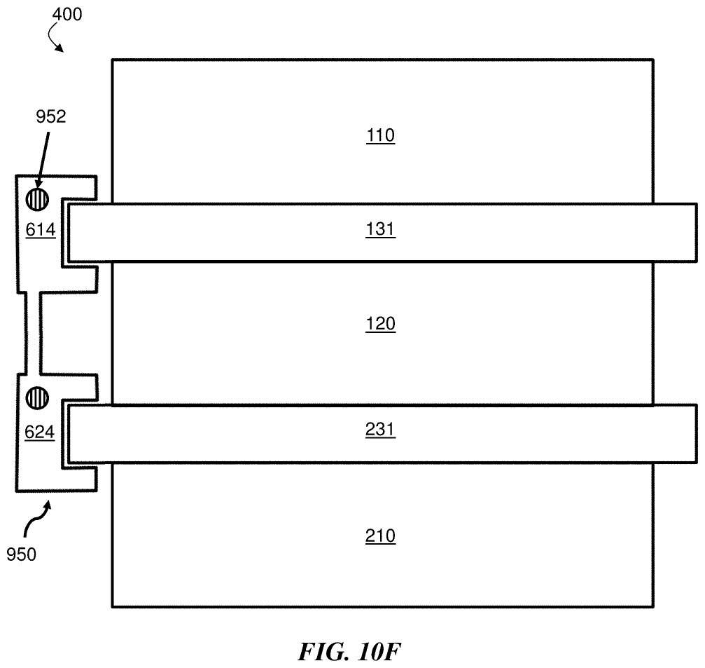

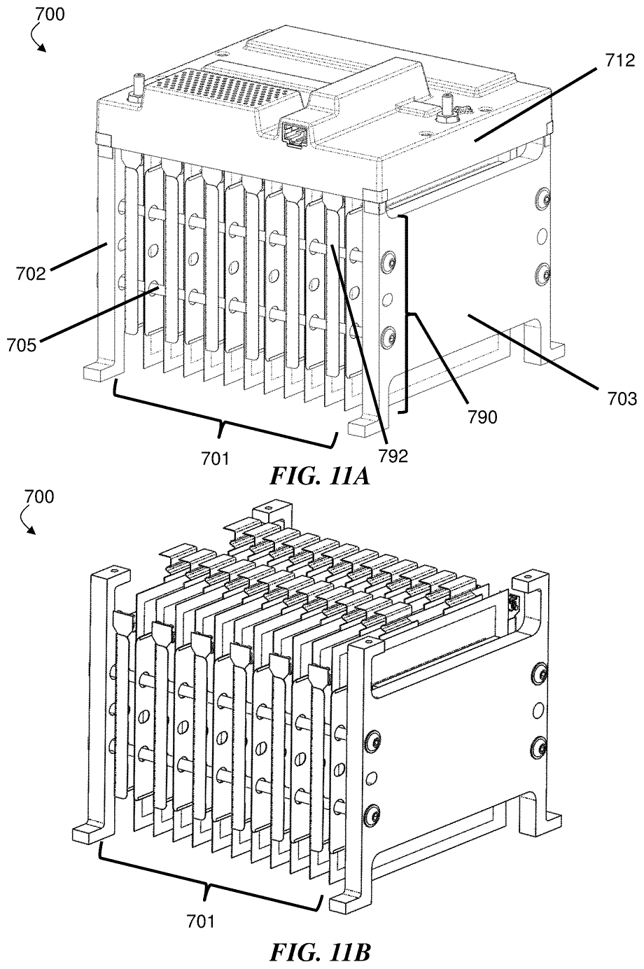

The dimensions of the thermally insulating compressible solid article portion may be chosen based on any of a variety of considerations. For example, the thickness (e.g., uncompressed thickness) or lateral dimensions may be chosen based on the desired total size of the battery and/or a desired pack burden (defined as one minus the mass of the electrochemical cells of the battery divided by the total mass of the battery). In some embodiments, the uncompressed thickness of the thermally insulating compressible solid article portion is such that a sufficient amount of compression can occur (e.g., to compensate for expansion of the first electrochemical cell and/or second electrochemical cell during cycling). In some embodiments, the arrangement of components of the stack of electrochemical cells are repeated. For example, in FIG. 10A, stack of electrochemical cells 400 comprises first electrochemical cell 110, first thermally conductive solid article portion 131, first heater 614, first thermally insulating compressible solid article portion 140, second thermally conductive solid article portion 231, second heater 624, second electrochemical cell 120, second thermally insulating compressible solid article portion 240, and third electrochemical cell 210.

In some embodiments, a thermally conductive solid article portion (e.g., first thermally conductive solid article portion, second thermally conductive solid article portion) is at least partially between electrochemical cells (e.g., first electrochemical cell, second electrochemical cell) in the stack of electrochemical cells. FIG. 2A and FIG. 2A show examples of such embodiments, where first thermally conductive solid article portion 131 is at least partially between first electrochemical cell 110 and second electrochemical cell 120. In certain embodiments, both a first thermally conductive solid article portion and a second thermally conductive solid article portion are at least partially between the first electrochemical cell and the second electrochemical cell. For example, referring again to FIG. 2A, first thermally conductive solid article portion 131 is at least partially between first electrochemical cell 110 and second electrochemical cell 120, and second thermally conductive solid article portion 132 is at least partially between first thermally conductive solid article portion 131 and second electrochemical cell 120. In some embodiments, a thermally insulating compressible solid article portion is at least partially between the first thermally conductive solid article portion and the second thermally conductive solid article portion. FIGS. 9A-9B show one such embodiment, where thermally insulating compressible solid article portion 140 of exemplary stack of electrochemical cells 100 is at least partially between first thermally conductive solid article portion 131 and second thermally conductive solid article portion 132.

In some embodiments, the first thermally conductive solid article portion and the second thermally conductive solid article portion are part of discrete articles. Referring again to FIG. 2A, in some embodiments first thermally conductive solid article portion 131 and second thermally conductive solid article portion 132 are separate, discrete articles (e.g., separate sheets or fins). However, in some embodiments, first thermally conductive solid article portion and the second thermally conductive solid article portion are part of the same article. For example, first thermally conductive solid article portion 131 and second thermally conductive solid article portion 132 may be connected via a third thermally conductive solid article portion (not pictured) in FIG. 2A. As one example, the stack of electrochemical cells may comprise a thermally conductive solid article that is foldable and/or has a serpentine shape such that electrochemical cells and/or other components of the stack of electrochemical cells can be arranged between portions of the thermally conductive solid article.

In some embodiments, the stack of electrochemical cells has more than one thermally conductive solid article portion. In some embodiments, the stack of electrochemical cells has more than one heater. In some embodiments, the stack of electrochemical cells has more than one thermally insulating compressible solid article portion. For example, FIG. 10A shows a cross-sectional schematic diagram of one such embodiment, where stack of electrochemical cells 400 comprises, in order: first electrochemical cell 110, first thermally conductive solid article portion 131 in thermal communication with first heater 614, first thermally insulating compressible solid article portion 140, second electrochemical cell 120, second thermally conductive solid article portion 231 in thermal communication with heater 624, second thermally insulating compressible solid article portion 240, and third electrochemical cell 210. In contrast, in other embodiments, a stack of electrochemical cells has exactly one thermally conductive solid article portion, and exactly one heater, as in the embodiment of FIG. 10B.

Although FIGS. 10A-10B present examples comprising thermally insulating compressible solid article portions 140, these are not essential, and in some embodiments the stack of electrochemical cells does not comprise thermally insulating compressible solid article portions. FIG. 10C shows a cross-sectional schematic diagram of one such embodiment, where stack of electrochemical cells 400 comprises, in order: first electrochemical cell 110, first thermally conductive solid article portion 131 in thermal communication with first heater 614, second electrochemical cell 120, second thermally conductive solid article portion 231 in thermal communication with heater 624, and third electrochemical cell 210.

It should be understood that the stack of electrochemical cells may not be limited to any particular number electrochemical cells, and may comprise at least 2, at least 3, at least 5, at least 8, at least 10, and/or up to 12, up to 15, up to 20, up to 24, up to 30 or more electrochemical cells. In some such cases, the total number of thermally conductive solid article portions is equal to the total number of electrochemical cells in the stack of electrochemical cells (e.g., 12 electrochemical cells and 12 thermally conductive solid article portions). In some such cases, the total number of heaters is equal to the total number of electrochemical cells in the stack of electrochemical cells (e.g., 12 electrochemical cells and 12 heaters). In some such cases, no thermally insulating compressible solid article portions are included, while in other such cases, the total number of thermally insulating compressible solid article portions is equal to one more than the total number of electrochemical cells in the stack of electrochemical cells (e.g., 12 electrochemical cells and 13 thermally insulating compressible solid article portions). For example, there may be an electrochemical cell between each of the thermally insulating compressible solid article portions, and a thermally conductive solid article layer adjacent to every electrochemical cell.

As described above, in some embodiments where a stack of electrochemical cells comprises more than one thermally conductive solid article portion, the stack comprises more than one heater in thermal communication with its thermally conductive solid article portions. Some or all of the heaters may be thermally insulated from one another, as in the example of FIG. 10A, and may be configured such that they are only mechanically connected via the stack. However, in some embodiments, some or all of the heaters are placed in thermal communication with one another, and the disclosure is not so limited.

In some embodiments, a stack of electrochemical cells comprises a thermal spreader. The thermal spreader can comprise, for example, a solid body that comprises thermally conductive material that facilitates heat transfer from one portion of the thermal spreader to another portion the thermal spreader. The thermal spreader may comprise one or more heaters. When the stack comprises more than one heater, a thermal spreader may be configured to mechanically couple at least some of the heaters, such that the mechanically coupled heaters would remain coupled even if the rest of the stack (e.g., the electrochemical cells, the thermally conducting solid article portions) were removed. In some embodiments, the thermal spreader permits thermal communication between a plurality of heaters. The thermal spreader may act as an intervening layer between a heater and a thermally conductive solid article portion. For example, the thermally conductive solid article portion and the heater may be placed in thermal communication via the thermal spreader. In some embodiments, a thermal spreader advantageously facilitates uniform dissipation of heat to one or more thermally conductive solid article portions. The thermal spreader may also include one or more electronic components (e.g., sensors, such as temperature sensors).

In some embodiments, a heater is in thermal communication with exactly one thermally conductive solid article portion. However, in some embodiments, a heater is in thermal communication with more than one thermally conductive solid article portion. For example, the heater may be part of a thermal spreader that places the heater in thermal communication with more than one thermally conductive solid article portions. Thus, the heater may be configured to heat more than one thermally conductive solid article portion. In some embodiments, e.g., a heater is in thermal communication with both a first thermally conductive solid article portion and a second thermally conductive solid article portion. Thus, the first thermally conductive solid article portion and the second thermally conductive solid article portion may be heated by a same heater (e.g., a single heater). FIG. 10D provides an example, where heater 914 is in thermal communication with first thermally conductive solid article portion 131 of stack 400, which is otherwise identical to stack 400 of FIG. 10C. In this embodiment, flows of heat 926 dissipated by heater 914 are transmitted to first thermally conductive solid article portion 131 and second thermally conductive solid article portion 231 via thermal spreader 950, which is configured to transmit heat from at least one heater to a plurality of thermally conductive solid article portions.

A thermal spreader may also comprise multiple heaters. For example, the thermal spreader may comprise one heater per thermally conductive solid article portion of the stack. In some embodiments, the heaters are in thermal communication with one another via the thermal spreader. FIG. 10E presents an example analogous to the example of FIG. 10C, but differing because first heater 614 and second heater 624 are part of thermal spreader 950 that mechanically couples them and that may place them in thermal communication. Of course, it should be understood that thermal spreader 914 may be thermally insulating, serving merely to mechanically couple the heaters. The embodiment is not thus limited.

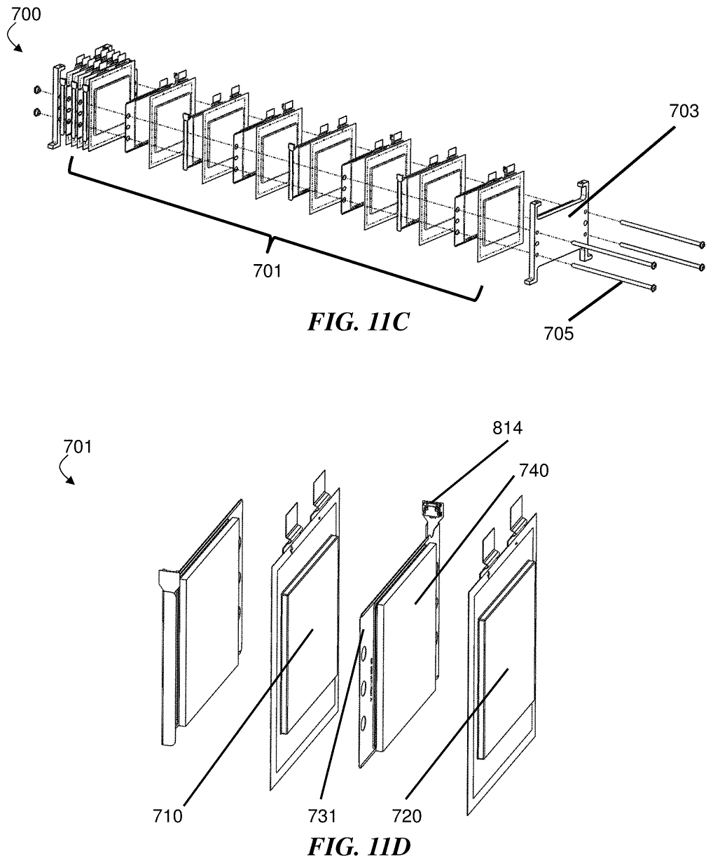

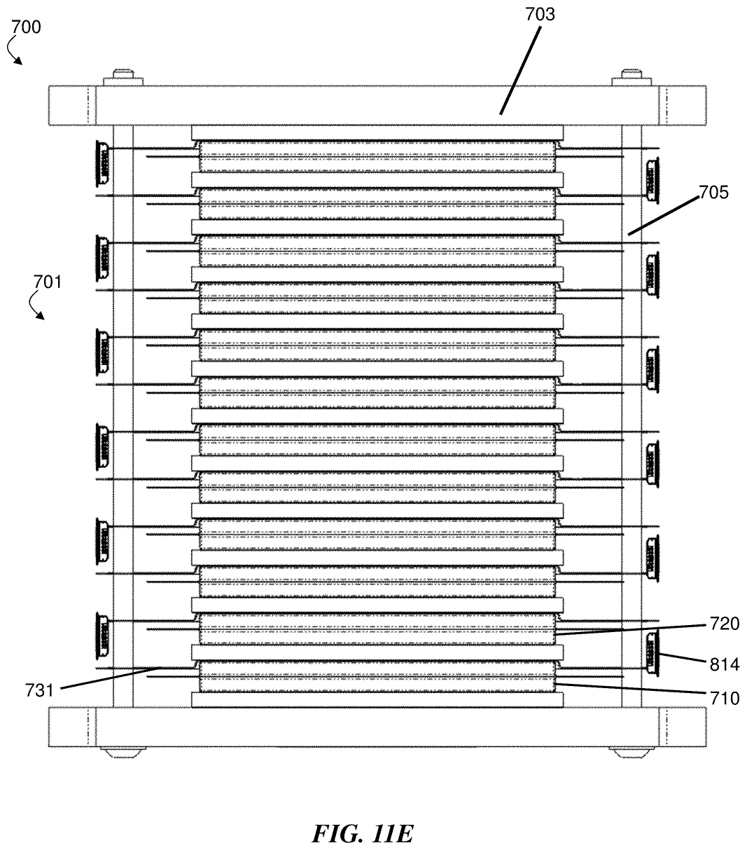

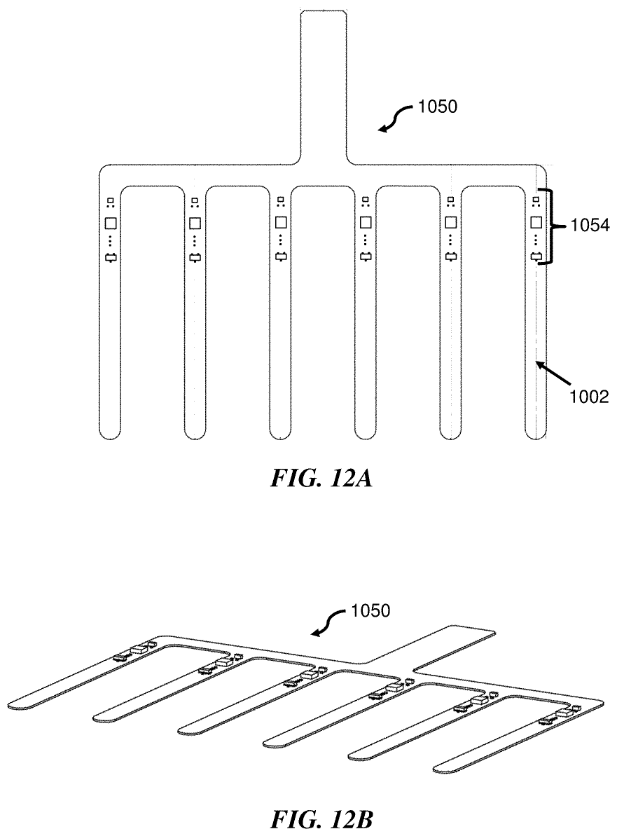

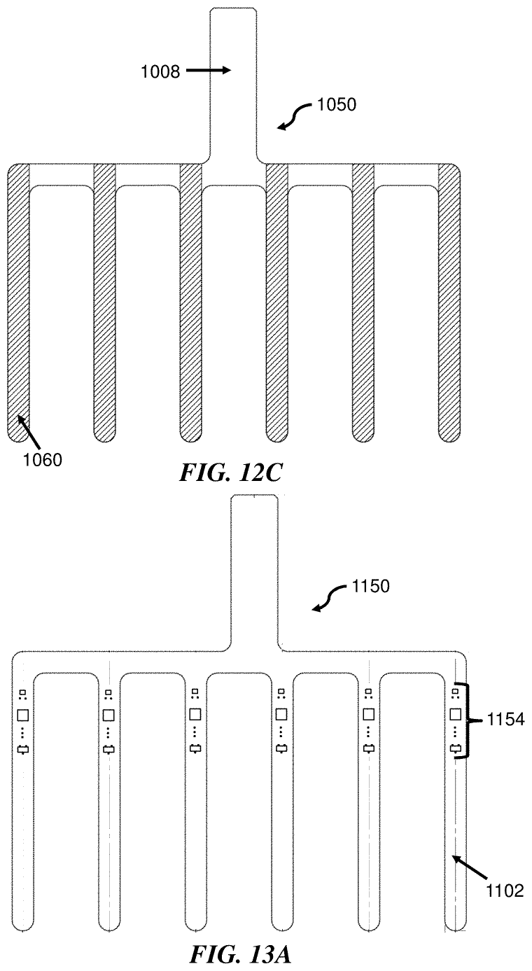

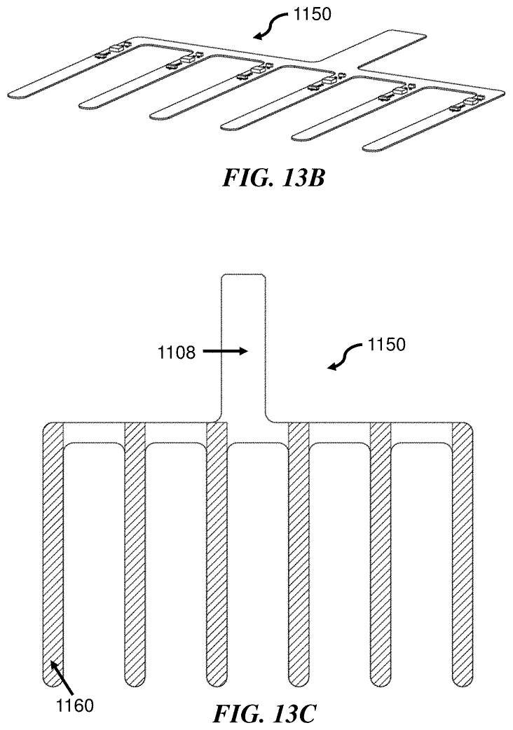

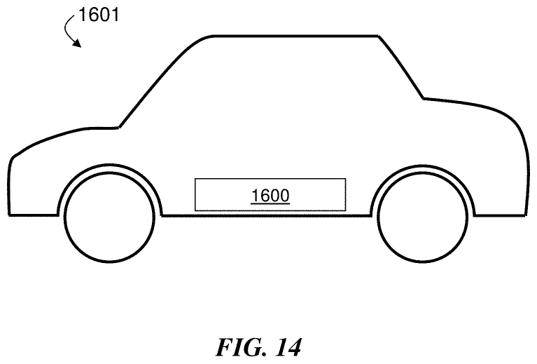

In some embodiments, the thermal spreader is flexible. The thermal spreader may comprise arms or other elongated portions that are configured to be connected to thermally conductive solid article portions. For example, each arm may comprise a heater and/or a temperature sensor, and these may be configured to regulate the temperature of the thermally conductive solid article portion to which the arm connects. In some embodiments, the thermal spreader comprises a tab (e.g., a lateral protrusion from the thermal spreader), as described below with reference to FIGS. 12C and 13C. The arms may, advantageously, be configured to contact a wide area of the thermally conductive solid article portion, to facilitate a more advantageous distribution of heat from the heater. Tabs may be used to align and/or connect distinct thermal spreaders. For example, in some embodiments, a stack of electrochemical cells comprises two thermal spreaders, joined by aligned tabs of the thermal spreaders. The inclusion of tabs may advantageously facilitate alignment of the thermal spreaders, or of an individual thermal spreader with a stack of electrochemical cells, during assembly.

A stack of electrochemical cells may comprise more than one thermal spreader. According to some embodiments, the stack of electrochemical cells comprises 2, 3, 4 or more thermal spreaders. For example, in some embodiments, the stack of electrochemical cells comprises a first thermal spreader disposed on a first side of the stack, and a second thermal spreader disposed on a second side of the stack. In some embodiments, this configuration advantageously allows the orientation of thermally conductive solid article portions to change, which can permit a larger region of the thermally conductive solid article portion to contact the thermal spreaders and/or heaters.

The thermal spreader may be mechanically coupled to the stack of the electrochemical cells in any of a variety of appropriate fashions. For example, the thermal spreader may be mechanically coupled to the stack using adhesives. Exemplary adhesives include adhesive layers, spray adhesives, and epoxies. However, a variety of other mechanisms for coupling the thermal spreader to the stack are also envisioned, such as the use of fasteners (e.g., screws, clips, clamps, bolts, etc.) or interlocking parts.

In some embodiments, the stack comprises one or more temperature sensors, as described in greater detail above. The temperature sensors may be in thermal communication with the heater and/or heaters. For example, the temperature sensor may be part of the thermal spreader. FIG. 10F provides an example, where temperature sensors 952 are located within heaters 614 and 624 of thermal spreader 950. Temperature sensors 952 may be used to detect the temperature of the heaters, as described above, and may be used to regulate the temperature of thermally conductive solid article portions 131 and 231. Although in temperature sensors 952 are part of thermal spreader 950, it should, of course, be understood that the temperature sensors could be located in any of a variety of appropriate locations within the stack of electrochemical cells (e.g., adjacent to thermally conductive solid article portions 131 or 231 of stack of electrochemical cells 400, or part of thermal spreader 950).

In some embodiments, the thermally insulating compressible solid article portion is porous. As one example, referring again to FIGS. 2A-2B, thermally insulating compressible solid article portion 140 is made of a porous material. As used herein, a “pore” refers to a pore as measured using ASTM Standard Test D4284-07, and generally refers to a conduit, void, or passageway, at least a portion of which is surrounded by the medium in which the pore is formed such that a continuous loop may be drawn around the pore while remaining within the medium. Generally, voids within a material that are completely surrounded by the material (and thus, not accessible from outside the material, e.g., closed cells) are not considered pores within this context. As such, a thermally insulating compressible solid article portion may be or comprise an open-cell solid, such an open-cell solid foam. It should be understood that, in cases where the thermally insulating compressible solid article portion comprises an agglomeration of particles, pores include both the interparticle pores (i.e., those pores defined between particles when they are packed together, e.g., interstices) and intraparticle pores (i.e., those pores lying within the envelopes of the individual particles). Pores may comprise any suitable cross-sectional shape such as, for example, circular, elliptical, polygonal (e.g., rectangular, triangular, etc.), irregular, and the like.

The porosity of a component of a battery (e.g., the thermally insulating compressible solid article portion comprising open cells) may be measured by physically separating the different regions of the electrochemical device by, for example, cutting out a region of the component, and then measuring the separated portion using the above-referenced ASTM Standard Test D4284-07.

In some instances, the thermally insulating compressible solid article portion (e.g., comprising an open-cell solid such as an open-cell foam) has a relatively high porosity. Having a relatively high porosity may contribute to the thermally insulating compressible solid article portion having a relatively low density, which in some instances can be advantageous as described above. A high porosity may also contribute, in some cases, to a relatively high compressibility. In some embodiments, the thermally insulating compressible solid article portion has a porosity of greater than or equal to 40%, greater than or equal to 50%, greater than or equal to 60%, or higher by volume. In some embodiments, the thermally insulating compressible solid article portion has a porosity of less than or equal to 90%, less than or equal to 80%, less than or equal to 70%, or less by volume. Combinations of these ranges are possible. For example, in some cases, the thermally insulating compressible solid article portion has a porosity of greater than or equal to 40% and less than or equal to 90%.

A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li₄Ti₅O₁₂, also referred to as “LTO”), tin-cobalt oxide, or any combinations thereof.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂O₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electroactive material of the second electrode comprises Li_{1.14}Mn_{0.42}Ni_{0.25}Co_{0.2902} (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

The cathode active material may be modified by a surface coating comprising an oxide. Non-limiting examples of surface oxide coating materials include: MgO, Al₂O₃, SiO₂, TiO₂, ZnO₂, SnO₂, and ZrO₂. Such coatings may prevent direct contact between the cathode active material and the electrolyte, thereby suppressing side reactions.

In certain embodiments, the cathode active material comprises sulfur. In some embodiments, the cathode active material comprises electroactive sulfur-containing materials. “Electroactive sulfur-containing materials,” as used herein, refers to electrode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within an electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

In some embodiments, the electrochemical cells further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator is permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Application Publication No. 2010/0035128 on Feb. 11, 2010, and entitled “Application of Force in Electrochemical Cells,” which is incorporated herein by reference in its entirety for all purposes.

In the embodiments described herein, batteries may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

In some embodiments, the battery (e.g., a housing of the battery) is configured to apply, during at least one period of time during charge and/or discharge of the device, an anisotropic force with a component normal to an electrode active surface of one of the electrochemical cells (e.g., first electrochemical cell, second electrochemical cell).

In some embodiments, an anisotropic force with a component normal to an electrode active surface of one of the electrochemical cells (e.g., first electrochemical cell, second electrochemical cell) is applied during at least one period of time during charge and/or discharge of the battery. In some embodiments, the force is applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the battery. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as a anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the battery, but the magnitude of the forces in out-of-plane directions is substantially unequal to the magnitudes of the in-plane forces.

In one set of embodiments, batteries (e.g., housings) described herein are configured to apply, during at least one period of time during charge and/or discharge of the cell, an anisotropic force with a component normal to an electrode active surface of one of the electrochemical cells (e.g., first electrochemical cell, second electrochemical cell). Those of ordinary skill in the art will understand the meaning of this. In such an arrangement, the electrochemical cell may be formed as part of a container which applies such a force by virtue of a “load” applied during or after assembly of the cell, or applied during use of the battery as a result of expansion and/or contraction of one or more components of the battery itself.

The magnitude of the applied force is, in some embodiments, large enough to enhance the performance of the battery. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean a battery that is identical, but where it is not constructed (e.g., by couplings such as brackets or other connections) to apply the anisotropic force on the subject battery.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may be under an externally-applied anisotropic force with a component defining a pressure of at least 10 kgf/cm², at least 20 kgf/cm², or more. This is because the yield stress of lithium is around 7-8 kgf/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 10 kgf/cm², at least about 20 kgf/cm², and/or up 30 kgf/cm², up to 40 kgf/cm² of externally-applied pressure, the lithium surface may become smoother with cycling when the pressing surface is smooth.

In some cases, one or more forces applied to the cell have a component that is not normal to an active surface of an anode. For example, in FIG. 4 force 184 is not normal to electrode active surfaces of the first electrochemical cell 110 and second electrochemical cell 120. In one set of embodiments, the sum of the components of all applied anisotropic forces in a direction normal to any electrode active surface of the battery is larger than any sum of components in a direction that is non-normal to the electrode active surface. In some embodiments, the sum of the components of all applied anisotropic forces in a direction normal to any electrode active surface of the battery is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode active surface.

In some cases, electrochemical cells may be pre-compressed before they are inserted into housings, and, upon being inserted to the house, they may expand to produce a net force on the electrochemical cells. Such an arrangement may be advantageous, for example, if the electrochemical cells are capable of withstanding relatively high variations in pressure.

FIGS. 11A-11B show perspective view schematic illustrations of battery 700 comprising stack of electrochemical cells 701, according to certain embodiments. Battery 700 shown in FIGS. 11A-11B comprises a plurality of electrochemical cells arranged in stack 701. Additional features of the battery, such as first solid plate 702, second solid plate 703, couplings 705, and electronics component 712 (e.g., comprising a printed circuit board) are shown in FIG. 11A, according to some embodiments. FIG. 11C shows an exploded perspective view schematic illustration of battery 700, while FIG. 11D shows an exploded perspective view schematic illustration of a portion of stack of electrochemical cells 701, according to certain embodiments, the portion comprising, in order, electrochemical cell 710, first thermally conductive solid article portion 731 (shown as an aluminum metal fin with locating holes and locating slots for alignment) in thermal communication with heater 814, thermally insulating compressible solid article portion 740 (shown as a sheet of microcellular foam), and second electrochemical cell 720. FIG. 11E shows a side view schematic diagram of battery 700 that comprises stack of electrochemical cells 701.

FIGS. 12A-12C present various orientations of an exemplary thermal spreader 1050, according to some embodiments. FIG. 12A presents a top-view schematic illustration of the exemplary thermal spreader, which comprises a plurality of arms 1002. Each arm 1002 comprises heater and a temperature sensor, included among electronics 1054, and each arm 1002 is configured to mechanically couple to a thermally conductive solid article portion of a stack of electrochemical cells. For example, arms 1002 of thermal spreader 1050 illustrated in FIG. 12A could be connected to edges 792 of thermally conductive solid article portions 731 on a first side 790 of stack of electrochemical cells 700 in FIG. 11A. The exemplary thermal spreader of FIGS. 12A-12C also comprises tab 1008, which may be folded around a stack of electrochemical cells, in some embodiments. Tab 1008 is centered with respect to arms 1002, in this exemplary embodiment. FIG. 12B presents a perspective, schematic illustration of thermal spreader 1050, and FIG. 12C presents a bottom-view schematic illustration of thermal spreader 1050, according to certain embodiments. As shown in FIG. 12C, the bottom of thermal spreader 1050 may comprise an adhesive 1060, although this is not required and any of a variety of methods may be used to mechanically couple arms of the thermal spreader to thermally conductive solid article portions.

FIGS. 13A-13C present different orientations of exemplary thermal spreader 1150, according to some embodiments. FIG. 13A presents a top-view schematic illustration of exemplary thermal spreader 1150, which comprises a plurality of arms 1102. Each arm comprises a heater and a temperature sensor, included among electronics 1154, and each arm 1102 is configured to couple to a thermally conductive solid article portion of a stack of electrochemical cells. For example, arms 1102 of thermal spreader 1150 illustrated in FIG. 13A could be connected to edges of thermally conductive solid article portions 705 on a second side (not shown) of stack of electrochemical cells 700, opposite first side 790 of stack of electrochemical cells 700 as shown in FIG. 11A. The exemplary thermal spreader of FIGS. 13A-13C also comprises tab 1108, which may be folded around a stack of electrochemical cells, in some embodiments. Tab 1108 is not centered with respect to arms 1102, since it is configured to align with tab 1008 of thermal spreader 1050, as shown in FIGS. 12A-12C, so that tabs 1008 and 1108 can be aligned. For example, in some embodiments tabs 1008 and 1108 can be aligned while thermal spreader 1050 is coupled to first side 790 of the stack and thermal spreader 1150 is coupled to the second side of the stack opposite first side 790. FIG. 13B presents a perspective, schematic illustration of thermal spreader 1150, and FIG. 13C presents a bottom-view schematic illustration of thermal spreader 1150, according to certain embodiments. As shown in FIG. 13C, the bottom of thermal spreader 1150 may comprise an exemplary adhesive 1160, although this is not required and any of a variety of methods may be used to mechanically couple arms of the thermal spreader to thermally conductive solid article portions.

In some embodiments, a stack of electrochemical cells and/or a battery comprising the stack (e.g., a rechargeable battery) described in this disclosure can be used to provide power to an electric vehicle or otherwise be incorporated into an electric vehicle. As a non-limiting example, stacks of electrochemical cells and/or batteries described in this disclosure (e.g., comprising lithium metal and/or lithium alloy electrochemical cells, thermally conducting solid article portions, thermally insulating solid article portions, and/or heaters) can, in certain embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, high altitude aircraft, spacecraft, and/or any other suitable type of vehicle. FIG. 14 shows a cross-sectional schematic diagram of electric vehicle 1601 in the form of an automobile comprising battery 1600, in accordance with some embodiments. Although FIG. 14 illustrates an automobile, this example is non-limiting, and it should be understood that the stack of electrochemical cells/battery can power other electric vehicles such as aircraft. Battery 1600 can, in some instances, provide power to a drive train of electric vehicle 1601.

The following applications are incorporated herein by reference, in their entirety, for all purposes: U.S. Patent Publication No. US 2007/0221265, published on Sep. 27, 2007, filed as application Ser. No. 11/400,781 on Apr. 6, 2006, and entitled “Rechargeable Lithium/Water, Lithium/Air Batteries”; U.S. Patent Publication No. US 2009/0035646, published on Feb. 5, 2009, filed as application Ser. No. 11/888,339 on Jul. 31, 2007, and entitled “Swelling Inhibition in Batteries”; U.S. Patent Publication No. US 2010/0129699, published on May 17, 2010, filed as application Ser. No. 12/312,674 on Feb. 2, 2010, patented as U.S. Pat. No. 8,617,748 on Dec. 31, 2013, and entitled “Separation of Electrolytes”; U.S. Patent Publication No. US 2010/0291442, published on Nov. 18, 2010, filed as application Ser. No. 12/682,011 on Jul. 30, 2010, patented as U.S. Pat. No. 8,871,387 on Oct. 28, 2014, and entitled “Primer for Battery Electrode”; U.S. Patent Publication No. US 2009/0200986, published on Aug. 31, 2009, filed as application Ser. No. 12/069,335 on Feb. 8, 2008, patented as U.S. Pat. No. 8,264,205 on Sep. 11, 2012, and entitled “Circuit for Charge and/or Discharge Protection in an Energy-Storage Device”; U.S. Patent Publication No. US 2007/0224502, published on Sep. 27, 2007, filed as application Ser. No. 11/400,025 on Apr. 6, 2006, patented as U.S. Pat. No. 7,771,870 on Aug. 10, 2010, and entitled “Electrode Protection in Both Aqueous and Non-Aqueous Electrochemical cells, Including Rechargeable Lithium Batteries”; U.S. Patent Publication No. US 2008/0318128, published on Dec. 25, 2008, filed as application Ser. No. 11/821,576 on Jun. 22, 2007, and entitled “Lithium Alloy/Sulfur Batteries”; U.S. Patent Publication No. US 2002/0055040, published on May 9, 2002, filed as application Ser. No. 09/795,915 on Feb. 27, 2001, patented as U.S. Pat. No. 7,939,198 on May 10, 2011, and entitled “Novel Composite Cathodes, Electrochemical Cells Comprising Novel Composite Cathodes, and Processes for Fabricating Same”; U.S. Patent Publication No. US 2006/0238203, published on Oct. 26, 2006, filed as application Ser. No. 11/111,262 on Apr. 20, 2005, patented as U.S. Pat. No. 7,688,075 on Mar. 30, 2010, and entitled “Lithium Sulfur Rechargeable Battery Fuel Gauge Systems and Methods”; U.S. Patent Publication No. US 2008/0187663, published on Aug. 7, 2008, filed as application Ser. No. 11/728,197 on Mar. 23, 2007, patented as U.S. Pat. No. 8,084,102 on Dec. 27, 2011, and entitled “Methods for Co-Flash Evaporation of Polymerizable Monomers and Non-Polymerizable Carrier Solvent/Salt Mixtures/Solutions”; U.S. Patent Publication No. US 2011/0006738, published on Jan. 13, 2011, filed as application Ser. No. 12/679,371 on Sep. 23, 2010, and entitled “Electrolyte Additives for Lithium Batteries and Related Methods”; U.S. Patent Publication No. US 2011/0008531, published on Jan. 13, 2011, filed as application Ser. No. 12/811,576 on Sep. 23, 2010, patented as U.S. Pat. No. 9,034,421 on May 19, 2015, and entitled “Methods of Forming Electrodes Comprising Sulfur and Porous Material Comprising Carbon”; U.S. Patent Publication No. US 2010/0035128, published on Feb. 11, 2010, filed as application Ser. No. 12/535,328 on Aug. 4, 2009, patented as U.S. Pat. No. 9,105,938 on Aug. 11, 2015, and entitled “Application of Force in Electrochemical Cells”; U.S. Patent Publication No. US 2011/0165471, published on Jul. 15, 2011, filed as application Ser. No. 12/180,379 on Jul. 25, 2008, and entitled “Protection of Anodes for Electrochemical Cells”; U.S. Patent Publication No. US 2006/0222954, published on Oct. 5, 2006, filed as application Ser. No. 11/452,445 on Jun. 13, 2006, patented as U.S. Pat. No. 8,415,054 on Apr. 9, 2013, and entitled “Lithium Anodes for Electrochemical Cells”; U.S. Patent Publication No. US 2010/0239914, published on Sep. 23, 2010, filed as application Ser. No. 12/727,862 on Mar. 19, 2010, and entitled “Cathode for Lithium Battery”; U.S. Patent Publication No. US 2010/0294049, published on Nov. 25, 2010, filed as application Ser. No. 12/471,095 on May 22, 2009, patented as U.S. Pat. No. 8,087,309 on Jan. 3, 2012, and entitled “Hermetic Sample Holder and Method for Performing Microanalysis under Controlled Atmosphere Environment”; U.S. Patent Publication No. US 2011/00765560, published on Mar. 31, 2011, filed as application Ser. No. 12/862,581 on Aug. 24, 2010, and entitled “Electrochemical Cells Comprising Porous Structures Comprising Sulfur”; U.S. Patent Publication No. US 2011/0068001, published on Mar. 24, 2011, filed as application Ser. No. 12/862,513 on Aug. 24, 2010, and entitled “Release System for Electrochemical Cells”; U.S. Patent Publication No. US 2012/0048729, published on Mar. 1, 2012, filed as application Ser. No. 13/216,559 on Aug. 24, 2011, and entitled “Electrically Non-Conductive Materials for Electrochemical Cells”; U.S. Patent Publication No. US 2011/0177398, published on Jul. 21, 2011, filed as application Ser. No. 12/862,528 on Aug. 24, 2010, and entitled “Electrochemical Cell”; U.S. Patent Publication No. US 2011/0070494, published on Mar. 24, 2011, filed as application Ser. No. 12/862,563 on Aug. 24, 2010, and entitled “Electrochemical Cells Comprising Porous Structures Comprising Sulfur”; U.S. Patent Publication No. US 2011/0070491, published on Mar. 24, 2011, filed as application Ser. No. 12/862,551 on Aug. 24, 2010, and entitled “Electrochemical Cells Comprising Porous Structures Comprising Sulfur”; U.S. Patent Publication No. US 2011/0059361, published on Mar. 10, 2011, filed as application Ser. No. 12/862,576 on Aug. 24, 2010, patented as U.S. Pat. No. 9,005,009 on Apr. 14, 2015, and entitled “Electrochemical Cells Comprising Porous Structures Comprising Sulfur”; U.S. Patent Publication No. US 2012/0070746, published on Mar. 22, 2012, filed as application Ser. No. 13/240,113 on Sep. 22, 2011, and entitled “Low Electrolyte Electrochemical Cells”; U.S. Patent Publication No. US 2011/0206992, published on Aug. 25, 2011, filed as application Ser. No. 13/033,419 on Feb. 23, 2011, and entitled “Porous Structures for Energy Storage Devices”; U.S. Patent Publication No. 2013/0017441, published on Jan. 17, 2013, filed as application Ser. No. 13/524,662 on Jun. 15, 2012, patented as U.S. Pat. No. 9,548,492 on Jan. 17, 2017, and entitled “Plating Technique for Electrode”; U.S. Patent Publication No. US 2013/0224601, published on Aug. 29, 2013, filed as application Ser. No. 13/766,862 on Feb. 14, 2013, patented as U.S. Pat. No. 9,077,041 on Jul. 7, 2015, and entitled “Electrode Structure for Electrochemical Cell”; U.S. Patent Publication No. US 2013/0252103, published on Sep. 26, 2013, filed as application Ser. No. 13/789,783 on Mar. 8, 2013, patented as U.S. Pat. No. 9,214,678 on Dec. 15, 2015, and entitled “Porous Support Structures, Electrodes Containing Same, and Associated Methods”; U.S. Patent Publication No. US 2013/0095380, published on Apr. 18, 2013, filed as application Ser. No. 13/644,933 on Oct. 4, 2012, patented as U.S. Pat. No. 8,936,870 on Jan. 20, 2015, and entitled “Electrode Structure and Method for Making the Same”; U.S. Patent Publication No. US 2014/0123477, published on May 8, 2014, filed as application Ser. No. 14/069,698 on Nov. 1, 2013, patented as U.S. Pat. No. 9,005,311 on Apr. 14, 2015, and entitled “Electrode Active Surface Pretreatment”; U.S. Patent Publication No. US 2014/0193723, published on Jul. 10, 2014, filed as application Ser. No. 14/150,156 on Jan. 8, 2014, patented as U.S. Pat. No. 9,559,348 on Jan. 31, 2017, and entitled “Conductivity Control in Electrochemical Cells”; U.S. Patent Publication No. US 2014/0255780, published on Sep. 11, 2014, filed as application Ser. No. 14/197,782 on Mar. 5, 2014, patented as U.S. Pat. No. 9,490,478 on Nov. 6, 2016, and entitled “Electrochemical Cells Comprising Fibril Materials”; U.S. Patent Publication No. US 2014/0272594, published on Sep. 18, 2014, filed as application Ser. No. 13/833,377 on Mar. 15, 2013, and entitled “Protective Structures for Electrodes”; U.S. Patent Publication No. US 2014/0272597, published on Sep. 18, 2014, filed as application Ser. No. 14/209,274 on Mar. 13, 2014, and entitled “Protected Electrode Structures and Methods”; U.S. Patent Publication No. US 2014/0193713, published on Jul. 10, 2014, filed as application Ser. No. 14/150,196 on Jan. 8, 2014, patented as U.S. Pat. No. 9,531,009 on Dec. 27, 2016, and entitled “Passivation of Electrodes in Electrochemical Cells”; U.S. Patent Publication No. US 2014/0272565, published on Sep. 18, 2014, filed as application Ser. No. 14/209,396 on Mar. 13, 2014, and entitled “Protected Electrode Structures”; U.S. Patent Publication No. US 2015/0010804, published on Jan. 8, 2015, filed as application Ser. No. 14/323,269 on Jul. 3, 2014, and entitled “Ceramic/Polymer Matrix for Electrode Protection in Electrochemical Cells, Including Rechargeable Lithium Batteries”; U.S. Patent Publication No. US 2015/044517, published on Feb. 12, 2015, filed as application Ser. No. 14/455,230 on Aug. 8, 2014, and entitled “Self-Healing Electrode Protection in Electrochemical Cells”; U.S. Patent Publication No. US 2015/0236322, published on Aug. 20, 2015, filed as application Ser. No. 14/184,037 on Feb. 19, 2014, and entitled “Electrode Protection Using Electrolyte-Inhibiting Ion Conductor”; U.S. Patent Publication No. US 2016/0072132, published on Mar. 10, 2016, filed as application Ser. No. 14/848,659 on Sep. 9, 2015, and entitled “Protective Layers in Lithium-Ion Electrochemical Cells and Associated Electrodes and Methods”; International Publication No. WO 2018/170413 A1, published on Sep. 20, 2018, file as Application No. PCT/US2018/022889on Mar. 16, 2018, and entitled “Electrode Edge Protection in Electrochemical Cells”; International Publication No. WO 2020/139802 A2, published on Jul. 2, 2020, file as Application No. PCT/US2019/068244 on Dec. 23, 2019, and entitled “Electrochemical Devices and Related Articles, Components, Configurations, and Methods”; International Application No. PCT/US2020/033938, filed on May 21, 2020, and entitled “Electrically Coupled Electrodes, and Associated Articles and Methods”; and International Application No. PCT/US2020/038375, filed on Jun. 18, 2020, and entitled “Methods, Systems, and Devices for Applying Forces to Electrochemical Devices.”

U.S. Patent Publication No. US 2021/0151839, published on May 20, 2021, filed as U.S. patent application Ser. No. 16/952,177 on Nov. 19, 2020, and entitled “Batteries, and Associated Systems and Methods,” U.S. patent application Ser. No. 16/952,182, filed Dec. 20, 2020, and entitled “Electrochemical Cell Stacks, and Associated Components,” U.S. Patent Publication No. US 2021/0151816 published on May 20, 2021, filed as U.S. patent application Ser. No. 16/952,223 on Dec. 20, 2020, and entitled “Thermally Insulating Compressible Components for Battery Packs,” U.S. Patent Publication No. US 2021/0151817 published on May 20, 2021, filed as U.S. patent application Ser. No. 16/952,228 on Dec. 20, 2020, and entitled “Battery Alignment, and Associated Systems and Methods,” U.S. Patent Publication No. US 2021/0151830 published on May 20, 2021, filed as U.S. patent application Ser. No. 16/952,235 on Dec. 20, 2020, and entitled “Batteries with Components Including Carbon Fiber, and Associated Systems and Methods,” U.S. Patent Publication No. US 2021/0151840 published on May 20, 2021, filed as U.S. patent application Ser. No. 16/952,187 on Nov. 19, 2020, and entitled “Compression Systems for Batteries,” U.S. Patent Publication No. US 2021/0151841 published on May 20, 2021, filed as U.S. patent application Ser. No. 16/952,240 on Nov. 19, 2020, and entitled “Systems and Methods for Applying and Maintaining Compression Pressure on Electrochemical Cells,” U.S. Patent Publication No. US 2021/0193984 published on Jun. 24, 2021, filed as U.S. patent application Ser. No. 17/125,124 on Dec. 17, 2020, and entitled “Systems and Methods for Fabricating Lithium Metal Electrodes,” U.S. Patent Publication No. US 2021/0193985 published on Jun. 24, 2021, filed as U.S. patent application Ser. No. 17/125,110 on Dec. 17, 2020, and entitled “Lithium Metal Electrodes and Methods,” U.S. Patent Publication No. US 2021/0193996 published on Jun. 24, 2021, filed as U.S. patent application Ser. No. 17/125,070 on Dec. 17, 2020, and entitled “Lithium Metal Electrodes,” U.S. Patent Publication No. US 2021/0194069 published on Jun. 24, 2021, filed as U.S. patent application Ser. No. 17/126,390 on Dec. 18, 2020, and entitled “Systems and Methods for Providing, Assembling, and Managing Integrated Power Bus for Rechargeable Electrochemical Cell Or Battery,” U.S. Patent Publication No. US 2021/0218243 published on Jul. 15, 2021, filed as U.S. patent application Ser. No. 17/126,424 on Dec. 18, 2020, and entitled “Systems and Methods for Protecting a Circuit, Rechargeable Electrochemical Cell, or Battery,” are each incorporated herein by reference in its entirety for all purposes.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

U.S. Provisional Patent Application No. 63/132,049 filed Dec. 30, 2020, and entitled “Temperature Management for Electrochemical Cells” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A stack of electrochemical cells, comprising:
a first electrochemical cell;
a second electrochemical cell;
a thermally conductive solid article portion at least partially between the first electrochemical cell and the second electrochemical cell; and
a heater in thermal communication with the thermally conductive solid article portion.

2. The stack of electrochemical cells of claim 1, wherein the heater is lateral to the first electrochemical cell.

3. The stack of electrochemical cells of claim 1, wherein the heater is configured to heat the first electrochemical cell such that under steady-state conditions, a temperature difference between any two points of the first electrochemical cell within a region of overlap between the second electrochemical cell and the thermally conductive solid article portion does not exceed 10° C.

4. The stack of electrochemical cells of claim 1, wherein the heater is configured to heat the second electrochemical cell such that under steady-state conditions, a temperature difference between any two points of the second electrochemical cell within a region of overlap between the second electrochemical cell and the thermally conductive solid article portion does not exceed 10° C.

5. The stack of electrochemical cells of claim 1, wherein the heater is a resistive heater.

6. The stack of electrochemical cells of claim 1, wherein the stack of electrochemical cells is electronically coupled to the heater.

7. The stack of electrochemical cells of claim 1, wherein the heater is configured to dissipate a thermal power of greater than or equal to 0.1 W.

8. The stack of electrochemical cells of claim 1, wherein the thermally conductive solid article portion comprises a metal or a metal alloy.

9. The stack of electrochemical cells of claim 1, wherein the stack of electrochemical cells is capable of maintaining a temperature of at least a portion of the stack of electrochemical cells of greater than or equal to 10° C. at ambient temperatures of greater than or equal to −90° C. and less than 10° C.

10. The stack of electrochemical cells of claim 1, wherein the thermally conductive solid article portion is in the form of a fin.

11. The stack of electrochemical cells of claim 1, wherein the thermally conductive solid article portion comprises carbon fiber.

12. The stack of electrochemical cells of claim 1, wherein the thermally conductive solid article portion comprises aluminum.

13. The stack of electrochemical cells of claim 1, wherein the thermally conductive solid article portion has an effective thermal conductivity of at least 10 W m⁻¹ K⁻¹ in a lateral direction at a temperature of 25° C.

14. The stack of electrochemical cells of claim 1, wherein the stack of electrochemical cells is at least partially enclosed by a housing applying an anisotropic force with a component normal to an electrode active surface of the first electrochemical cell and/or an electrode active surface of the second electrochemical cell defining a pressure of at least 10 kgf/cm².

15. The stack of electrochemical cells of claim 1, wherein the stack of electrochemical cells is at least partially enclosed by a housing configured to apply, during at least one period of time during charge and/or discharge of the first electrochemical cell and/or the second electrochemical cell, an anisotropic force with a component normal to an electrode active surface of the first electrochemical cell and/or an electrode active surface of the second electrochemical cell defining a pressure of at least 10 kgf/cm².

16. The stack of electrochemical cells of claim 1, wherein the first electrochemical cell and/or the second electrochemical cell comprises lithium metal and/or a lithium metal alloy as an electrode active material.

17. The stack of electrochemical cells of claim 1, wherein the heater is in thermal communication with a temperature sensor.

18. The stack of electrochemical cells of claim 1, wherein the thermally conductive solid article portion is a first thermally conductive solid article portion, and wherein the stack of electrochemical cells further comprises a second thermally conductive solid article portion at least partially between the second electrochemical cell and a third electrochemical cell of the stack of electrochemical cells. 9891640.1

19. The stack of electrochemical cells of claim 18, wherein the heater is in thermal communication with both the first thermally conductive solid article portion and the second thermally conductive solid article portion.

20-22. (canceled)

23. A method, comprising:
heating a region of a thermally conductive solid article portion to form a heated region, wherein:
the thermally conductive solid article portion is at least partially between a first electrochemical cell and a second electrochemical cell of a stack of electrochemical cells, and
the heating of the region results in at least some heat from the heated region of the thermally conductive solid article portion being transferred to the first electrochemical cell.

24-45. (canceled)
